(19) United States
(12) Patent Application Publication
(10) Pub. No.: US 2026/0153823 A1
(43) Pub. Date: Jun. 4, 2026

(54) HEATING MEMBER, FIXING DEVICE, AND IMAGE FORMING APPARATUS

(71) Applicant: CANON KABUSHIKI KAISHA, Tokyo (JP)

(72) Inventor: KAZUHIRO DODA, Kanagawa (JP)

(21) Appl. No.: 19/389,358

(22) Filed: Nov. 14, 2025

(30) Foreign Application Priority Data
Dec. 2, 2024 (JP) 2024-209634

(51) Int. Cl. G03G 15/20; H05B 3/00

(52) U.S. Cl. CPC G03G 15/2053; G03G 15/2064; H05B 3/0014; G03G 2215/2025; H05B 2203/007

(57) ABSTRACT

A heating member includes a substrate, a first heat generating element, a second heat generating element, and a third heat generating element. A combined resistance of the first heat generating element and the second heat generating element is smaller than a resistance of the third heat generating element. Along a longitudinal direction of the substrate, the third heat generating element includes a first portion having a length shorter than respective lengths of the first and second heat generating elements, and includes a second portion and a third portion on mutually opposite longitudinal sides of the first portion, each of the second and third portions having a lower resistance of the first portion. The second portion, the first portion, and the third portion are connected in series with each other in this order.

### FIELD OF THE TECHNOLOGY

The present disclosure relates to a heating member, a fixing device, and an image forming apparatus, and relates to an image forming apparatus provided with a fixing device for fixing a toner image formed on a sheet, for example, in an electrophotographic printer or an electrophotographic copying machine, for forming an image on a recording material.

### DESCRIPTION OF THE RELATED ART

A conventional fixing device heat-fixes an unfixed toner image, formed on a sheet, on the sheet. For this reason, in the case where an A5-size sheet narrow in width is used, there is a liability that a temperature increases in a non-sheet-passing region and causes an image defect. In a conventional image forming apparatus, productivity thereof is lowered by increasing an interval between a sheet and a subsequent sheet, so that temperature rise of the non-sheet-passing region is reduced. On the other hand, in United State Patent Publication No. US2020/0233352 proposes a heater including heat generating elements having three kinds of lengths. The heater includes a heat generating element [1] having a length corresponding to an A4-size sheet width, a heat generating element [2] having a length corresponding to a B5-size sheet width, and a heat generating element [3] having a length corresponding to an A4-size sheet width. By using the heat generating element, to which an AC voltage is applied, in a switching manner depending on a condition, the temperature rise of the non-sheet-passing region when the sheet narrow in width is used is suppressed, so that high productivity is provided to a user. Further, in a rising operation, the heat generating element [1] low in electric resistance value is used, and the heat generating element [1] is formed in a parallel pattern of two lines. On the other hand, each of the heat generating elements [2] and [3] is made high in electric resistance value and is formed in a single wire pattern of one line. By this, a size of a substrate is minimized, and in addition, the temperature rise of the non-sheet-passing region is suppressed, so that the productivity of the sheet narrow in width is enhanced.

Further, in United State Patent Publication No. US2021/0072681, a control example of heat generating elements having three kinds of lengths is disclosed. When an electric power supply time (power supply time) when a long heat generating element is used is T1 and a power supply time when a short heat generating element is used is T2, the heat generating elements used are alternately switched so that a ratio between T1 and T2 becomes a target value. In the case where printing is executed in a state in which a fixing device is cool, a ratio of the power supply time T1 is made high, and the heat generating element having a wide width is used frequently. On the other hand, in the case where the printing is executed in a state in which the fixing device is hot, a ratio of the power supply time T2 is made high, and the heat generating element having a narrow width is used frequently. Thus, depending on an accumulation state of the fixing device, the power supply time ratio between the heat generating elements is controlled. By this, excessive temperature rise of the non-sheet-passing region is suppressed, so that productivity of the sheet having the narrow width is enhanced.

However, there is the following problem in the case where heat generating elements different in electric resistance value are used in a switching manner. For example, when A5-size sheets are passed through the fixing device, control for switching between the heat generating element [1] and the heat generating element [2] which are largely different in electric resistance value of the heat generating element, and therefore, a change in current amount when the heat generating element is switched is large. When the current amount is large, there is a case where a potential fluctuation in AC voltage is caused. Then, when the AC voltage is fluctuated in a certain period, there is a case that a flicker phenomenon (for example, a phenomenon such that illumination, a screen of television, or the like flicks, or the like phenomenon) is caused in some cases in another electrical equipment to which (electric) power is supplied from the same AC power source as the fixing device used.

### SUMMARY

The present disclosure has been accomplished in view of the above-described circumstances and is directed to suppress a flicker phenomenon while realizing downsizing and in addition, improving productivity of printing.

According to an aspect of the present disclosure, there is provided a heating member comprising: a substrate; a first heat generating element disposed at one end portion of the substrate in a widthwise direction of the substrate; a second heat generating element disposed at the other end portion of the substrate in the widthwise direction and electrically connected in parallel with the first heat generating element; and a third heat generating element disposed between the first heat generating element and the second heat generating element in the widthwise direction, wherein a combined resistance of the first heat generating element and the second heat generating element is smaller than a resistance of the third heat generating element, and wherein along a longitudinal direction of the substrate, the third heat generating element includes a first portion having a length shorter than respective lengths of the first and second heat generating elements, and includes a second portion and a third portion on mutually opposite longitudinal sides of the first portion, each of the second and third portions having a lower resistance of the first portion, and wherein the second portion, the first portion, and the third portion are connected in series with each other in this order.

According to another aspect of the present disclosure, there is provided a fixing device for fixing a toner image on a recording material, comprising: the above-described heating member; a switching unit configured to selectively supply power either to the first and second heat generating elements or to the third heat generating element; and a control unit configured to control the switching unit, wherein the control unit is configured to increase a proportion of time during which power is supplied to the third heat generating element as a temperature of the fixing device indicative of a heat accumulation amount, detected by a temperature sensor, increases.

According to a further aspect of the present disclosure, there is provided an image forming apparatus comprising: an image forming unit configured to form a toner image on a recording material; and the above-described fixing device, in which the toner image formed by the image forming unit is fixed.

According to the present disclosure, it is possible to suppress the flicker phenomenon while realizing downsizing and in addition, improving the productivity of the printing.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view showing a constitution of an image forming apparatus according to embodiments 1 and 2.

FIG. 2 is a block diagram showing an image forming process in the embodiments 1 and 2.

Parts (a) to (d) FIG. 3 are a schematic sectional views each showing a constitution of each of fixing devices according to the embodiment 1 and 2.

Parts (a) and (b) of FIG. 4 are schematic views showing a heater and a power control circuit, respectively, in the embodiment 1.

Parts (a) and (b) of FIG. 5 are schematic views showing a heater and a power control circuit, respectively, in a comparison example.

Parts (a) and (b) of FIG. 6 are schematic views showing a heater and a power control circuit, respectively, in the embodiment 2.

### DESCRIPTION OF THE EMBODIMENTS

### General Fixing Device

A general fixing device heats and fixes a toner image, formed on a sheet, on the sheet by using a heating member including a heat generating element which is capable of conveying the sheet in a nip (hereinafter, referred to as sheet passing) and which has a width substantially equal to a maximum sheet width (hereinafter, this width is referred to as a maximum width). On the other hand, a sheet size used by a user includes various large and small sizes, such as an A4 size, a B5 size, and an A5 size. In the case where an A4-size sheet wide in width is used, the sheet passes through over a whole area of a region in which the sheet is heated by the heating member including the heat generating element having the maximum width (hereinafter, this region is referred to as a heating region), so that the heater and the fixing device maintains a uniform temperature in the whole area. On the other hand, in the case were an A5-size sheet narrow in width is used, the sheet does not always passes through over the whole area of the heating region of the heating member including the heat generating element having the maximum width. That is, in a part of the heating region, the A5-size sheet passes, but in another part of the heating region, the A5-size sheet does not pass. In a region in which the sheet passes (hereinafter, this region is referred to as a sheet passing region), the sheet takes heat from the fixing device, and therefore, the fixing device in the sheet passing region is low in temperature. On the other hand, in a region in which the sheet does not pass (hereinafter, this region is referred to as a non-sheet-passing region), the sheet does not take heat from the fixing device, and therefore, the fixing device in the non-sheet-passing region becomes high in temperature (hereinafter, referred to as temperature rise). By this temperature rise of the non-sheet-passing region, there is a liability that an image defect occurs. In the case of the general fixing device, in order to cool the non-sheet-passing region, control such that productivity is lowered by increasing an interval between a sheet and a (subsequent) sheet when sheets are continuously conveyed in some instances.

On the other hand, there is an example in which a heater includes heat generating elements having three kinds of lengths on a substrate. The heat generating elements having the three kinds of lengths are a heat generating element [1] having a length corresponding to an A4-size sheet width, a heat generating element [2] having a length corresponding to a B5-size sheet width, and a heat generating element [3] having a length corresponding to an A5-size sheet width. A constitution in which the temperature rise of the non-sheet-passing region when the sheet narrow in width is passed through the heat generating elements is suppressed by using the heat generating elements, to which an AC voltage of an AC power source is applied, in a switch manner depending on a condition and which thus provides the user with high productivity is proposed.

In order to shift the fixing device to a sheet passable state, there is a need to heat the fixing device in advance. This is referred to as a rising operation. When a time required for the rising operation (hereinafter, this time is referred to as a rising operation time) is shorter, the user is capable of obtaining a print in a shorter time. For that reason, it is desirable that an electric resistance value of the heat generating element [1] used in the rising operation is low and that a maximum heat generation amount is large. When the heat generating element [1] is used in the rising operation, the rising operation time can be shortened. However, when a temperature difference in the substrate is increased by that large energy partially concentrates on the substrate and a temperature of only a part of the substrate reaches a high temperature or the like, there is a possibility that the substrate largely deforms. For this reason, there is a need to uniformize the large energy imparted to the substrate, so that it is desirable that the heat generating element [1] is formed in a parallel pattern of two lines.

On the other hand, the number of lines of the heat generating elements may preferably be small in order to realize downsizing of the heater. On the assumption that the heat generating elements [2] and [3] re not used in the rising operation, the maximum heat generation amount may be small. That is, electric resistance values of the heat generating elements [2] and [3] may be large. The maximum heat generation amount is small, so that even when the energy imparted to the substrate is not uniformized, deformation of the substrate is not large. Therefore, different from the heat generating element [1], each of the heat generating elements [2] and [3] can employ a single wire pattern of one line. Incidentally, in a conventional example 1, an AC voltage is applied to only either one of the heat generating elements [1], [2]. and [3], so that the heat generating element to which the AC voltage is applied is caused to generate heat. The heat generating element to which the AC voltage is applied is switched at a predetermined timing. In addition, the AC voltage is not applied to the different heat generating elements at the same time. By this, it is possible to minimize a size of the substrate and to suppress the temperature rise of the non-sheet-passing region when the sheet narrow in width is passed. That is, the interval between the sheets does not need to be increased, and therefore, productivity of the sheet narrow in width can be enhanced.

Further, as a use method of the heat generating elements when the sheet narrow in width is passed, there are two methods. A first method is the case where the heat generating element [1] and the heat generating element [2] are used, and a second method is the case where the heat generating element [1] and the heat generating element [3] are used. In either case, the AC voltage is applied to only either one of a longer heat generating element and a shorter heat generating element. Here, a time in which the power is supplied in the case where the longer heat generating element is used is referred to as a power supply time T1. Further, a time in which the power is supplied in the case where the shorter heat generating element is used is referred to as a power supply time T2. The heat generating elements used are alternately switched so that a ratio between the power supply time T1 and the power supply time T2 becomes a target value. The ratio between the power supply time T1 and the power supply time T2 is different depending on a heat accumulation state of the fixing device.

In the case where a heat accumulation amount of the fixing device is small and the fixing device is in a cooled state, viscosity of grease in a fixing film is high, so that a force (torque) necessary to rotate a pressing roller is large. In the case where this force is large, when a temperature difference between the sheet passing region and the non-sheet-passing region becomes large, there is a liability that the fixing film is largely deformed. For this reason, in the case where printing is executed in a state in which the fixing device is cool, control is made so that a ratio of the power supply time T1 becomes high, so that the heat generating element wide in width is frequently used. Incidentally, the heat generating element large in maximum heat generation amount is wider in width than the sheet narrow in width, so that although excessive temperature rise of the non-sheet-passing region is concerned, the fixing device is heated from the cooled state, and thus it takes time to increase the temperature of the fixing device. In a time until this temperature rise, even when the heat generating element wide in width is frequently used, the non-sheet-passing region does not reach a state of the excessive temperature rise.

On the other hand, in the case where the heat accumulation amount of the fixing device is large and the printing is executed in a state in which the fixing device is hot, control is made so that a ratio of the power supply toner T2 becomes high. In the case where the fixing device is hot the viscosity of the grease in the fixing film is low, and the force (torque) necessary to rotate the pressing roller is small, so that a risk of deformation of the fixing film is small. Therefore, control is made so that the heat generating element narrow in width is frequently used and the non-sheet-passing region does not reach the state of the excessive temperature rise. By this, depending on the heat accumulation state of the fixing device, a power supply time ratio between the heat generating elements can be controlled, the excessive temperature rise of the non-sheet-passing region can be suppressed, and productivity of the sheet narrow in width can be enhanced.

In the following, embodiments of the present disclosure will be described while making reference to the drawings.

### Embodiment 1

### Image Forming Apparatus

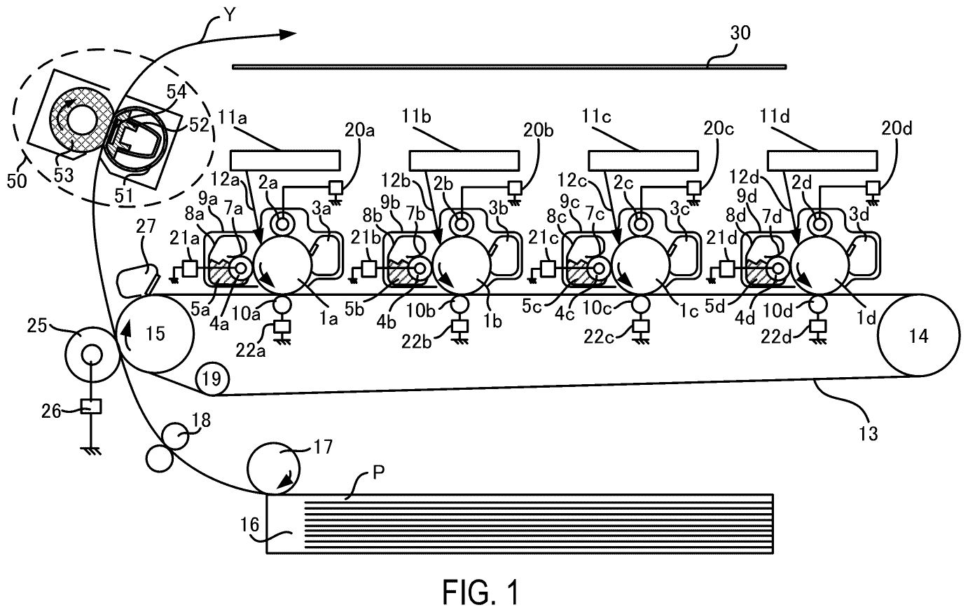

FIG. 1 is a schematic sectional view showing a structure of an in-line color image forming apparatus which is an example of an image forming apparatus in which a fixing device according to an embodiment 1 is mounted. An operation of the color image forming apparatus of an electrophotographic type will be described using FIG. 1. Incidentally, a first station is a station for forming a toner image of yellow (Y), and a second station is a station for forming a toner image of magenta (M). Further, a third station is a station for forming a toner image of cyan (C), and a fourth station is a station for forming a toner image of black (K).

In the first station, a photosensitive drum 1a as an image bearing member is an organic photoconductor (OPC) photosensitive drum. The photosensitive drum 1a comprises a plurality of lamination layers of functional organic materials, including a carrier generating layer for generating electric charges on a metal cylinder through light exposure and a charge transporting layer for transporting the generated electric charges, and the like layer, and an outermost layer thereof is low in electrical conductivity and which is substantially insulative. A charging roller 2a which is a charging means is contacted to the photosensitive drum 1a and electrically charges a surface of the photosensitive drum 1a uniformly while being rotated with rotation of the photosensitive drum 1a. To the charging roller 2a, a voltage superpose d with a DC voltage or an AC voltage is applied, so that electric discharge generates from a nip between the surfaces of the charging roller 2a and the photosensitive drum 1a in minute air gaps on sides upstream and downstream of the nip with respect to a rotational direction of the photosensitive drum 1a, whereby the photosensitive drum 1a is charged.

A cleaning unit 3a is a unit for removing toner remaining on the photosensitive drum 1a after transfer described later. A developing unit 8a which is a developing means includes a developing roller 4a, non-magnetic one-component toner 5a, and a developer application blade 7a. The photosensitive drum 1a, the charging roller 2a, the cleaning unit 3a, and the developing unit 8a constitute an integral process cartridge 9a mountable in and demountable from the image forming apparatus.

An exposure device 11a which is an exposure means is constituted by a scanner unit or an LED (light emitting diode) array for scanning the photosensitive drum 1a with laser light reflected by a polygonal mirror, and the surface of the photosensitive drum 1a is irradiated with a scanning beam 12a modulated on the basis of an image signal. Further, the charging roller 2a is connected to a charging voltage power source 20a which is a voltage supplying means to the charging roller 2a. The developing roller 4a is connected to a developing voltage power source 21a which is a voltage supplying means to the developing roller 4a. A primary transfer roller 10a is connected to a primary transfer voltage power source 22a which is a voltage supplying means to the primary transfer roller 10a. The above is a constitution of the first station, and the second to fourth stations have similar constitutions. As regards the second to fourth (other) stations, component elements having the same functions as those in the first station are represented by the same reference numerals, and associated suffixes b, c and d are added to the reference numerals for the respective stations. Incidentally, in the following description, the suffixes a, b, c, and d will be omitted except for the case where a specific station is described.

An intermediary transfer belt 13 is supported by three rollers, as stretching members therefor, consisting of a secondary transfer opposite roller 15, a tension roller 14, and an auxiliary roller 19. To only the tension roller 14, a force in a direction in which the intermediary transfer belt 13 is stretched is applied by a spring, so that proper tension is maintained for the intermediary transfer belt 13. The secondary transfer opposite roller 15 is rotated by receiving rotational drive from a main motor (not shown), so that the intermediary transfer belt 13 surrounding an outer periphery of the secondary transfer opposite roller 15 is rotated. The intermediary transfer belt 13 is moved in a forward direction (for example, the clockwise direction in FIG. 1) relative to the photosensitive drums 1a to 1d (for example, rotate in the counterclockwise direction in FIG. 1) substantially at the same speed. Further, the intermediary transfer belt 13 is rotated in an arrow direction (clockwise direction), and the primary transfer roller 10 is disposed on a side opposite from the photosensitive drum 1 while sandwiching the intermediary transfer belt 13 therebetween, so that the primary transfer roller 10 is rotated with movement of the intermediary transfer belt 13. A position where the photosensitive drum 1 and the primary transfer roller 10 are in contact with each other while sandwiching the intermediary transfer belt 13 therebetween is referred to as a primary transfer position. The auxiliary roller 19, the tension roller 14 and the secondary transfer opposite roller 15 are electrically grounded. Incidentally, primary transfer rollers 10b to 10d of the second to fourth stations also have constitutions similar to the constitution of the primary transfer roller 10a of the first station, and therefore, will be omitted from description.

### Image Forming Operation

Next, an image forming operation of the image forming apparatus of the embodiment 1 will be described. When the image forming apparatus receives a print instruction when the image forming apparatus is in a stand-by state, the image forming apparatus starts the image forming operation. The photosensitive drum 1 and the intermediary transfer belt 13, and the like start rotations in the arrow directions in FIG. 1 at a predetermined process speed by the main motor (not shown). The photosensitive drum 1a is electrically charged uniformly by the charging roller 2a to which a voltage is applied by the charging voltage power source 20a, and then is exposed to the scanning beam 12a emitted from the exposure device 11a, so that an electrostatic latent image in accordance with image information is formed on the photosensitive drum 1a. Toner 5a in the developing unit 8a is negatively charged by the developer applying blade 7a and is applied onto the developing roller 4a. Then, to the developing roller 4a, a predetermined developing voltage is supplied by the developing voltage power source 21a. The photosensitive drum 1a is rotated, and when the electrostatic latent image formed on the photosensitive drum 1a reaches the developing roller 4a, the electrostatic latent image is visualized by deposition of the negatively charged toner 5a thereon, so that a toner image of a first color (for example, Y (yellow)) is formed in the photosensitive drum 1a. The stations (process cartridges 9b to 9d) for other colors of M (magenta), C (cyan) and K (black) similarly operate.

At certain timings, depending on distances between the respective primary transfer positions for the colors, the electrostatic latent images by exposure are formed on the photosensitive drums 1a to 1d while delaying writing signals from a controller (not shown). To each of the primary transfer rollers 10a to 10d, a high DC voltage of a polarity opposite to a charge polarity of the toner 5a is applied. By the above-described steps, the toner images are successively transferred onto the intermediary transfer belt 13 (hereinafter, this transfer is referred to as primary transfer), so that multiple-toner images are formed on the intermediary transfer belt 13. Thereafter, in synchronism with the toner image formation, a sheet P which is a recording material stacked on a sheet (paper) feeding cassette 16 is conveyed along a conveying path Y Specifically, the sheet P is fed (picked up) by a sheet (paper) feeding roller 17 rotationally driven by a sheet (paper) feeding solenoid (not shown).

The fed sheet P is conveyed to a registration roller pair 18 by conveying rollers. The sheet P is conveyed to a transfer nip, which is a contact portion between the intermediary transfer belt 13 and a secondary transfer roller 25, by the registration roller pair 18 in synchronism with the toner images on the intermediary transfer belt 13. To the secondary transfer roller 25, a voltage of a polarity opposite to the charge polarity of the toner 5 is applied by a secondary transfer voltage power source 26, so that the multiple toner images of the four colors carried on the intermediary transfer belt 13 are collectively transferred onto the sheet (recording material) P (hereinafter, this transfer is referred to as secondary transfer). Members contributing to the image forming operation until the unfixed toner images are formed on the sheet P (for example, the photosensitive drum 1 and the like) function as an image forming unit. On the other hand, after the secondary transfer is ended, the toner 5 remaining on the intermediary transfer belt 13 is removed by a cleaning unit 27. The sheet P after the secondary transfer is ended is conveyed toward a fixing device 50 which is a fixing means and is subjected to fixing of the toner image, and then is discharged as an image-formed product (print, copy) onto a discharge tray 30. A fixing film 51, a nip-forming member 52, a pressing roller 53, and a heater 54 of the fixing device 50 will be described later.

### Block Diagram of Image Forming Apparatus

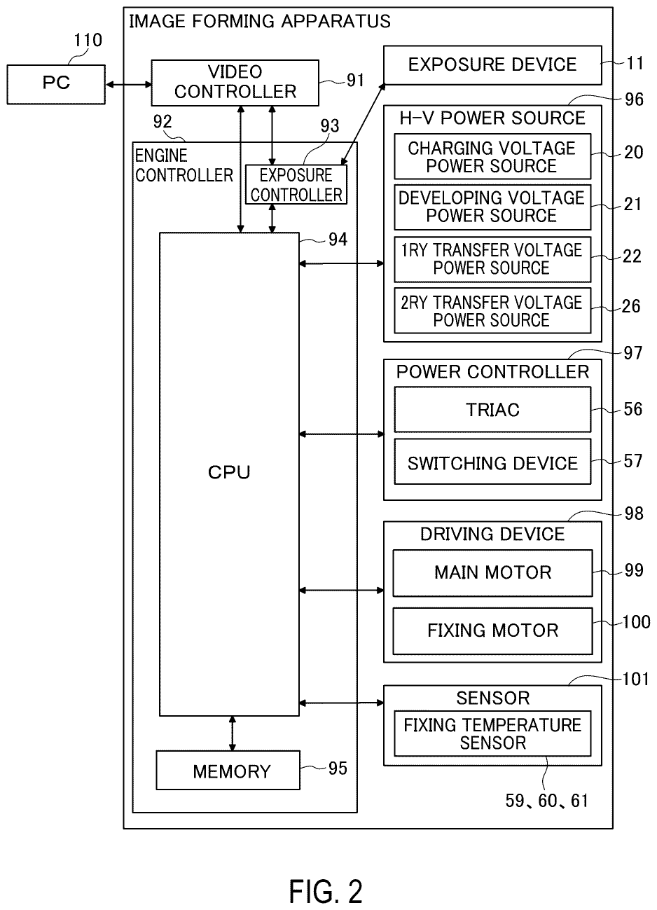

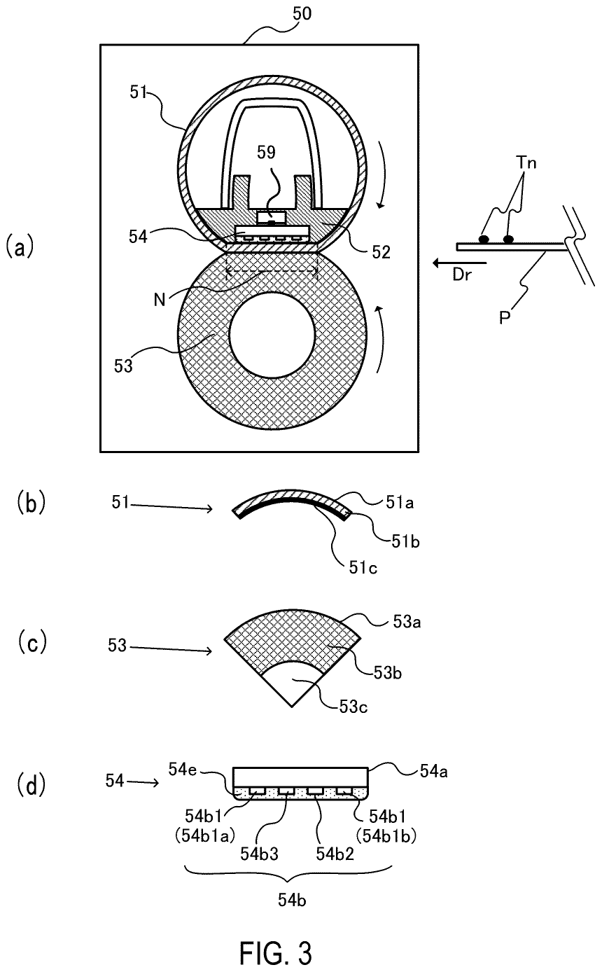

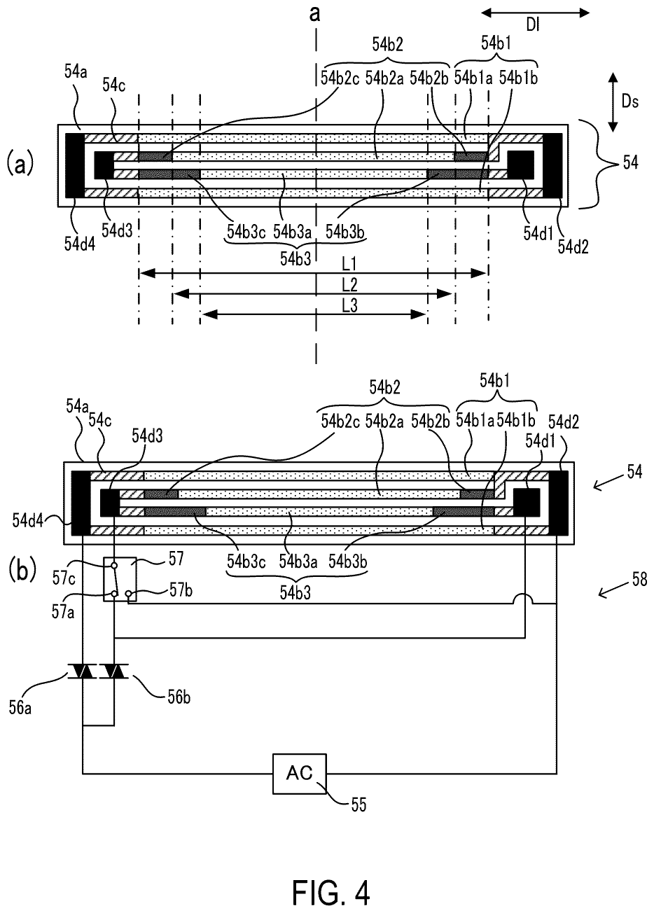

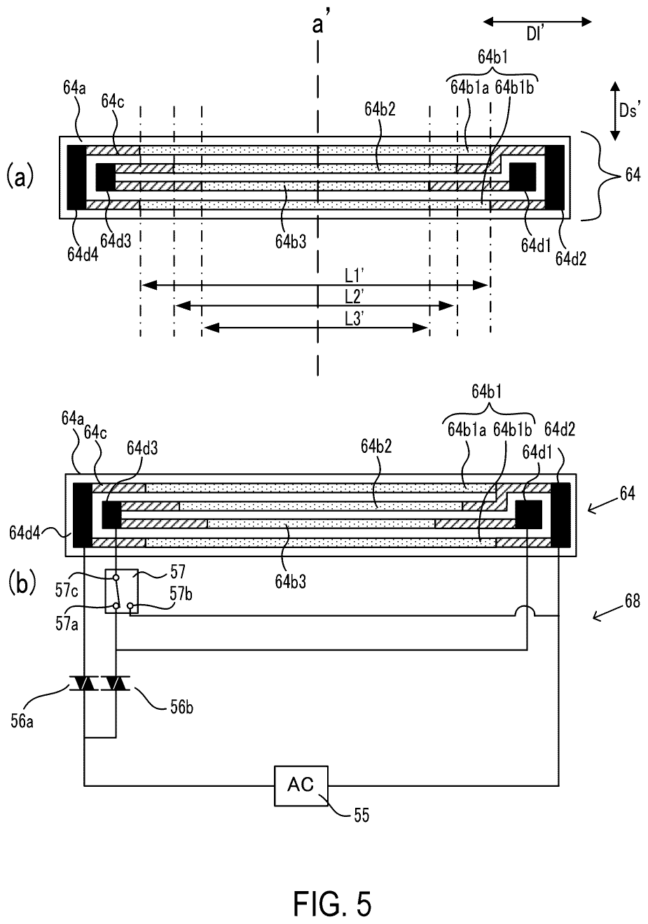

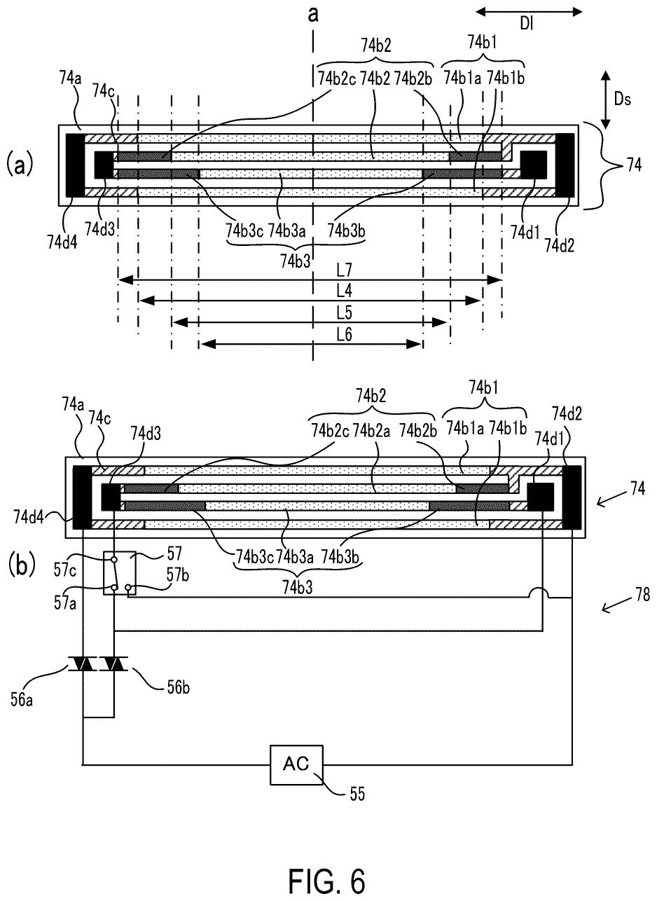

FIG. 2 is a block diagram for illustrating an operation of the image forming apparatus, and a printing operation of the image forming apparatus will be described while making reference to FIG. 2. A PC 110 which is a host computer outputs a print (printing) instruction to a video controller 91 provided inside the image forming apparatus, and has a function of transferring sheet information, printed sheet number information, and image data of a print image to the video controller 91. The video controller 91 selects a sheet passing mode on the basis of sheet information and notifies the selected sheet passing mode to an engine controller 92.

In conformity to a sheet size designated by the PC 110 which is a designating means (hereinafter, this size is referred to as a designated sheet size), a size of image data (hereinafter, this size is referred to as an image size) is determined. Incidentally, a sheet size inputted from an input portion (not shown) provided in the image forming apparatus may be used as the designated sheet size, and in this case, the input portion corresponds to the designating means. In the embodiment 1, a size obtained by subtracting 5 mm for each of sheet side margins, i.e., 10 mm in total for opposite side margins, of the sheet (paper) from the designated sheet size is the sheet size. The video controller 91 converts the image data sent from the PC 110 into the exposure data, and transfers the exposure data to an exposure control device (exposure controller) 93 provided in the engine controller 92. The exposure control device 93 is controlled from the CPU 94, and performs turning-on and turning-off of the exposure data and control of the exposure device 11. A size of the exposure data is determined by the image size. The CPU 94 which is a control unit starts an image forming sequence when receives the printing instruction.

In the engine controller 92, the CPU 94, a memory 95 and the like are mounted, and the engine controller 92 performs an operation programmed in advance. A high-voltage power source 96 is constituted by the charging voltage power source 20, the developing voltage power source 21, the primary transfer voltage power source 22, and the secondary transfer voltage power source 26 which are described above. Further, an electric power controller 97 is constituted by a bidirectional thyristor (hereinafter, referred to as a triac) 56, and a switching device 57 as a switching unit for exclusively selecting the heat generating element to which the (electric) power is supplied, and the like. The switching device 57 is, for example, an electromagnetic relay. For example, the CPU 94 switches whether to supply the power to a first heat generating element and a second heat generating element which are described later or the supply the power to a third heat generating element described later by switching the switching device 57 through the electric power controller 97.

The electric power controller 97 selects the heat generating element generating heat in the fixing device 50 and determines an amount of (electric) power supplied. Further, a driving device 98 is constituted by the main motor 99, the fixing motor 100, and the like. Further, a sensor 101 includes fixing temperature sensors 59, 60, and 61 for detecting the temperature of the fixing device 50, and the like, and detection result of the sensor 101 is sent to the CPU 94. The CPU 94 acquires the detection result of the sensor 101 in the image forming apparatus, and controls the exposure device 11, a high-voltage (H-V) power source 96, the electric power controller 97, and the driving device 98. By this, the CPU 94 carries out formation of the electrostatic latent image, transfer of the toner image into which the electrostatic latent image is developed, fixing of the toner image on the sheet P, and the like, and thus carries out control of an image forming step in which exposure data is printed as the toner image on the sheet P. Incidentally, the image forming apparatus to which the present disclosure is applied is not limited to the image forming apparatus having the constitution described with reference to FIG. 1, but may only be required to be an image forming apparatus capable of printing images on sheets P different in width and including the fixing device 50 provided with the heater 54 described later.

### Fixing Device

Next, a constitution of the fixing device 50 in the embodiment 1 will be described using a schematic sectional view of the fixing device 50 shown in part (a) of FIG. 3. Here, the longitudinal direction is a rotational axis direction of the pressing roller 53, described later, substantially perpendicular to a conveying direction Dr of the sheet P. Further, a length of the sheet P in a direction (longitudinal direction) substantially perpendicular to the conveying direction Dr is referred to as a width. The sheet P holding thereon an unfixed toner image Tn is heated while being conveyed from right to left in part (a) of FIG. 3 in a fixing nip (nip) N, whereby the toner image Tn is fixed on the sheet P. The fixing device 50 in the embodiment 1 is constituted by the fixing film (film) 51, the nip-forming member 52 for holding the fixing film 51, the pressing roller 53 for forming the fixing nip N in cooperation with the fixing film 51, and the heater 54 for heating the sheet P.

Detailed contents of respective component parts will be described.

### Fixing Film 51

The fixing film 51 which is as a first rotatable member is a cylindrical rotatable member. In the part (b) of FIG. 3, a part of a layer structure of the fixing film 51 is shown. The fixing film 51 is constituted by forming, on a base layer 51c using polyimide as a base material, an elastic layer 51b formed of a silicone rubber and a parting layer 51 a formed of PFA. The fixing film 51 is 18 mm in outer diameter and 222 mm in length in the longitudinal direction. A thickness of the base layer 51c 60 μm, a thickness of the elastic layer 51 b is 180 μm, and a thickness of the parting layer 51 a is 15 μm. In order to reduce a frictional force generated between the nip-forming member 52 and the heater 54, and the fixing film 51 by rotation of the fixing film 51, grease is applied onto an inner surface of the fixing film 51.

### Nip-Forming Member 52

The nip-forming member 52 performs a function of not only guiding the fixing film 51 from an inside and but also forming the fixing nip N between itself and the pressing roller 53 through the fixing film 51. The nip-forming member 52 is a member having rigidity, a heat-resistant property, and a heat-insulating property, and is formed of a liquid crystal polymer, or the like. The fixing film 51 is externally fitted to the nip-forming member 52.

### Pressing Roller 53

The pressing roller 53 which is a second rotatable member is a roller as a rotatable pressing member. In part (c) of FIG. 3, a layer structure of the pressing roller 53 is shown. The pressing roller 53 is consisting of a core metal 53c, an elastic layer 53b, and a parting layer 53a. The pressing roller 53 is rotatably held in opposite end portions thereof with respect to a rotational direction and is rotationally driven by a fixing motor 100 (see FIG. 2). Further, by rotation of the pressing roller 53, the fixing film 51 is rotated. An outer diameter of the pressing roller 53 is 18 mm, and an outer diameter of the core metal 53c is 11 mm. Therefore, the elastic layer 53b has a thickness of about 3.5 mm. The parting layer 53a has a thickness of 30 μm.

### Heater 54

The heater 54 as a heating member is provided in an inside space of the fixing film 51, and the heater 54 and the pressing roller 53 nip the fixing film 51. The heater 54 is constituted by a substrate, a heat generating element, an electroconductor, a contact, and a protecting glass. Part (d) of FIG. 3 is a sectional view of the heater 54. The substrate 54a is formed of alumina (Al₂O₃) which is ceramic. As the ceramic substrate, substrates formed of the alumina (Al₂O₃), aluminum nitride (AlN), zirconia (ZrO₂), silicon carbide (SiC), and the like are widely known, and among these, the alumina (Al₂O₃) is in expensive and easily available. Further, as a material of a substrate 54a, metal excellent in strength may be used, and as the metal substrate, a stainless steel (SUS) substrate is excellent in cost and strength and is suitably used. In either one of the ceramic substrate and the metal substrate, in the case where the substrate has electroconductivity, the substrate may only be required to be used after being provided with an insulating layer. On the substrate 54a, a heat generating element 54b, the electroconductor (not shown), and the contact (not shown) are formed, and thereon, a protective glass layer 54e is formed in order to ensure insulation between the heat generating element 54b and the fixing film 51.

The heater 54 which is the heating member is held by the nip-forming member 52, and contacts an inner surface of the fixing film 51. The heater 54 includes heat generating elements 54b1 (54b1a, 54b1b), 54b2, and 54b3. The heat generating elements 54b1 (54b1a, 54b1b), 54b2, and 54b3 are also collectively referred to as a heat generating element 54b.

### Fixing Temperature Sensor 59

The fixing temperature sensor 59 is a temperature detecting means. The fixing temperature sensor 59 is constituted by a thermistor element, a holder, ceramic paper, and an insulating resin sheet. The fixing temperature sensor 59 is contact-disposed on a surface, of the heater 54, opposite from the protective glass layer 54e, i.e., on a substrate 54a side. The ceramic paper performs a function of inhibiting heat conduction between the holder and the thermistor element. The insulating resin sheet performs a function of physically and electrically protecting the thermistor element. The thermistor element is the temperature detecting means which is changed in output value depending on a temperature of the heater 54 and is connected to the CPU 94 by Dumet wire (not shown) and wiring. The thermistor element detects the temperature of the heater 54 and outputs a detection result to the CPU 94. The CPU 94 controls the temperature of the heater 54 during fixing processing on the basis of the fixing temperature sensor 59.

### Detailed Description of Heat Generating Elements of Heater 54

The heat generating element 54b of the heater 54 is a feature of the embodiment 1. Details of the heat generating element 54b of the heater 54 will be described using part (a) of FIG. 4. Part (a) of FIG. 4 is a schematic view showing a constitution of the heater 54 when the heater 54 on which the heat generating element 54b is disposed is viewed from above. On the substrate 54a, the heat generating elements 54b1, 54b2, and 54b3, a conductor 54c, and contacts 54d1 to 54d4 are formed, and thereon, in order to ensure insulation between each heat generating element 54b and the fixing film 51, the protective glass layer 54e is formed. A reference line a is a center line of the heat generating elements 54b1, 54b2, and 54b3 with respect to a longitudinal direction Dl and is also a center line of the sheet P, conveyed to the fixing device 50, with respect to a longitudinal direction of the sheet P.

The heat generating element 54b1 is a heat generating element including a heat generating element 54b1a as a first heat generating element and a heat generating element 54b1 as a second heat generating element which have a length L1 of 222 mm in the longitudinal direction D0 and which are connected in parallel with each other. Specifically, with respect to a widthwise direction (short direction) Ds perpendicular to the longitudinal direction Dl, the heat generating element 54b1a is provided in one end portion of the substrate 54a, and the heat generating element 54b1 is provided in the other end portion of the substrate 54a. A synthetic electric resistance value R1 of the two heat generating elements 54b1a and 54b1b is 10.7 Ω. The heat generating element 54b1 is caused to generate heat by applying an AC voltage to between the contact 54d2 and the contact 54d4.

The heat generating element 54b2 is an heat generating element including heat generating elements 54b2c, 54b2a, and 54b2b which are connected in series with each other in this order. The heat generating element 54b2c has a length of 17 mm in the longitudinal direction Dl, the heat generating element 54b2a has a length L2 of 188 mm in the longitudinal direction Dl, and the heat generating element 54b2b has a length of 17 mm in the longitudinal direction Dl, and a film thickness of each of these heat generating elements is 10 μm. A sum of the lengths of the heat generating elements 54b2c, 54b2a, and 54b2b is 222 mm and is equal to the length L1 of the heat generating element 54b1. An electric resistance value of the heat generating element 54b2a is 19 Ω, and an electric resistance value of each of the heat generating elements 54b2b and 54b2c is 0.34 Ω. That is, the electric resistance value (19 Ω) of the heat generating element 54b2a positioned in a central portion with respect to the longitudinal direction D1 is larger than the electric resistance value (0.34 Ω) of each of the heat generating elements 54b2b and 54b2c positioned in end portions with respect to the longitudinal direction Dl. The heat generating element 54b2 is caused to generate heat by applying an AC voltage to between the contact 54d3 and the contact 54d2.

With respect to the longitudinal direction Dl, an electric power amount per unit length is defined as a heat generation density. A ratio of heat generation density of the heat generating elements 54b2c and 54b2b to the heat generation density of the heat generating element 54b2a is 5:1. In order to realize this heat generation density, there is a need to determine an electric resistivity ρ2a of the heat generating element 54b2a and electric resistivities ρ2c and ρ2b of the heat generating elements 54b2c and 54b2b. A relationship between the electric resistivity ρ2a, the electric resistivity ρ2b, and the electric resistivity ρ2c is ρ2a=⅕×ρ2c=⅕×ρ2b.

In order to make a heat generation ratio between the sheet passing region and the non-sheet-passing region substantially the same between the case where heat generating elements 64b1 and 64b2 are used in a power supply time ratio of 2:8 in a comparison example 1 and the case where only the heat generating element 54b2 is used in the embodiment 1, a heat generation density ratio is designed to 1:5. Incidentally, when voltages having the same voltage value are applied to the heat generating element 54b2 in the embodiment 1 and the heat generating element 64b2 in the comparison example 1, electric resistance values are designed so that electric power values of the heat generating element 64b2 and the heat generating element 54b2 coincide with each other. Lengths of the heat generating elements 64b2 and 54b2 in the longitudinal direction Dl are the same (L2=188 mm), and heat generation densities thereof when the same voltage is applied thereto are also the same.

The heat generating element 54b3 as a third heat generating element is an heat generating element including heat generating elements 54b3c as a third portion, 54b3a as a first portion, and 54b3b as a second portion which are connected in series with each other in this order. The heat generating element 54b3c has a length of 34 mm in the longitudinal direction Dl, the heat generating element 54b3a has a length L3 of 154 mm in the longitudinal direction Dl, and the heat generating element 54b3b has a length of 34 mm in the longitudinal direction Dl, and a film thickness of each of these heat generating elements is 10 μm. A sum of the lengths of the heat generating elements 54b3c, 54b3a, and 54b3b is 222 mm and is equal to the length L1 of the heat generating element 54b1. An electric resistance value of the heat generating element 54b3a is 20.3 Ω, and an electric resistance value of each of the heat generating elements 54b3b and 54b3c is 0.9 Ω. That is, the heat generating element 54b3 includes the heat generating element 54b3a shorter than each of the heat generating elements 54b1a and 54b1b, and each of the heat generating elements 54b3b and 54b3c (0.9 Ω) is lower in electric resistance value than the heat generating element 54b3a (20.3 Ω).

The heat generating element 54b3 is caused to generate heat by applying an AC voltage to between the contact 54d3 and the contact 54d1. The heat generating elements 54b2 and 54b3 are provided between the heat generating element 54b1a and the heat generating element 54b1b with respect to the widthwise direction Ds. That is, with respect to the widthwise direction Ds, on the substrate 54a, the heat generating elements 54b1a, 54b2, 54b3, and 54b1b are disposed in this order.

With respect to the longitudinal direction Dl, an electric power amount per unit length is defined as a heat generation density. A ratio of heat generation density of the heat generating elements 54b3c and 54b3b to the heat generation density of the heat generating element 54b3a is 5:1. In order to realize this heat generation density, there is a need to determine an electric resistivity ρ3a of the heat generating element 54b3a and electric resistivities ρ3c and ρ3b of the heat generating elements 54b3c and 54b3b. A relationship between the electric resistivity ρ3a, the electric resistivity ρ3b, and the electric resistivity ρ3c is ρ3a=⅕×ρ3c=⅕×ρ3b.

In order to make a heat generation ratio between the sheet passing region and the non-sheet-passing region substantially the same between the case where heat generating elements 64b1 and 64b3 are used in a power supply time ratio of 2:8 in a comparison example 1 and the case where only the heat generating element 54b3 is used in the embodiment 1, a heat generation density ratio is designed to 1:5. Incidentally, when voltages having the same voltage value are applied to the heat generating element 54b3 in the embodiment 1 and the heat generating element 64b3 in the comparison example 1, electric resistance values are designed so that electric power values of the heat generating element 64b3 and the heat generating element 54b3 coincide with each other. Lengths of the heat generating elements 64b3 and 54b3 in the longitudinal direction Dl are the same (L3=154 mm), and heat generation densities thereof when the same voltage is applied thereto are also the same.

Depending on a sheet width of the sheet P passed, the heat generating element 54b used is different. In the case of the A4-size sheet, the heat generating element 54b1 having the length corresponding to an A4-size sheet width is used. In the case of the B5-size sheet, the heat generating element 54b1 and the heat generating element 54b2 having a length corresponding to a B5-size sheet width are alternately used in a switching manner. In the case of the A5-size sheet, the heat generating element 54b1 and the heat generating element 54b3 having a length corresponding to an A5-size sheet width are alternately used in a switching manner.

### Switching of Heat Generating Element

Part (b) of FIG. 4 is a schematic view showing a constitution of a power control circuit 58 of the heater 54. The power control circuit 58 of the heater 54 includes triacs 56a and 56b for performing connection and disconnection of a power supplying path from an AC power source 55 to the heat generating elements 54b1, 54b2, and 54b3, and includes the switching device 57 for switching the heat generating element 54b for supplying the (electric) power.

The triac 56a performs connection (ON) or disconnection (OFF) of a power supplying path between the AC power source 55 and the contact 54d4 of the heater 54. On the other hand, the triac 56b performs connection (ON) or disconnection (OFF) of a power supplying path between the AC power source 55 and the switching device 57 or between the AC power source 55 and the contact 54d1 of the heater 54.

The switching device 57 is a C contact relay as a heat generating element control unit for controlling power supply to the plurality of heat generating elements 54b and switches the power supplying path so as to connect the contact 54d3 of the heater 54 with the triac 56 or the AC power source 55. Specifically, the switching device 57 includes contacts 57a, 57b, and 57c. The switching device 57 connects the contact 54d3 of the heater 54 with the triac 56b when the contact 57a and the contact 57c are connected with each other, and the contact 54d3 of the heater 54 with the AC power source 55 when the contact 57b and the contact 57c are connected with each other. Incidentally, the contact 54d2 of the heater 54 is always connected with the AC power source 55.

For example, in the case where the electric power is supplied from the AC power source 55 to the heat generating element 54b1, the triac 56a is turned on (ON), so that the AC power source 55 and the contact 54d4 of the heater 54 are connected with each other. In the embodiment 1, the two triacs 56a and 56b are not used simultaneously. That is, the two triacs 56a and 56b are not in an ON state at the same time.

In the case where the electric power is supplied from the AC power source 55 to the heat generating element 54b2, the AC power source 55 and the switching device 57 are connected with each other by turning on (ON) the triac 56b, and then the switching device 57 is controlled so as to connect the contact 54d3 of the heater 54 with the triac 56b. That is, in the switching device 57, the contact 57a and the contact 57c are connected with each other.

In the case where the electric power is supplied from the AC power source 55 to the heat generating element 54b3, the switching device 57 is controlled so that the contact 54d3 of the heater 54 is connected with the AC power source 55 by turning on (ON) the triac 56b. That is, in the switching device 57, the contact 57b and the contact 57c are connected with each other.

### Electric Power Amount Control

The fixing temperature sensor 59 is disposed in the neighborhood of the reference line a, i.e., in the center with respect to the longitudinal direction Dl. The CPU 94 checks a detection result of the fixing temperature sensor 59 and a target temperature. Depending on a difference between the detection result and the target temperature, the CPU 94 calculates an amount of the electric power supplied to the heat generating element 54b, and controls the amount of the electric power supplied to the heat generating element 54b, and controls the amount of the electric power supplied to the heat generating element 54b. For example, in the case where the AC power source 55 is 60 Hz in frequency, an AC waveform of 60 cycles (cyclic periods) per (one) second exists. This waveform of one cycle is defined as one wave. The one wave is constituted by two half-waves (positive half-wave and negative half-wave). The CPU 94 executes wave number control such that turning-on (ON) and turning-off (OFF) of the triacs 56a and 56b are controlled every half-wave. Only in an ON state of the triacs 56a and 56b, the AC voltage is applied to the heat generating element 54b. In the embodiment 1, the CPU 94 discriminates that the triacs 56a and 56b are turned on (ON) in a period corresponding to how many half-waves, every 8 half-waves from the difference between the detection result of the fixing temperature sensor 59 and the target temperature. That is, one control cycle of the wave-number control is the 8 half-waves. The CPU 94 controls ON/OFF of the triacs 56a and 56b on the basis of the discrimination. For example, in the case where the CPU 94 executes turning-on (ON) of the triacs 56 a and 56b in all the 8 half-waves, electric power in a maximum electric power amount capable of being supplied per unit time is supplied to the heat generating element 54b. In the case where the turning-on of the triacs 56a and 56b is instructed to only in one half-wave of the 8 half-waves, electric power in an electric power amount corresponding to ⅛ of the maximum electric power amount capable of being supplied per unit time is supplied to the heat generating element 54.

### Power Supply Time Ratio Control

In the case where the sheet narrow in width is passed (through the fixing nip), power supply time ratio control is carried out. The power supply time ratio control will be described using part (a) of FIG. 4 by taking the case where the A5-size sheet is passed, as an example. In the case where the A5-size sheet is passed, the heat generating element 54b1 and 54b3 are alternately used in a switching manner. To only the heat generating element 54 used, the AC voltage is applied. As regards the AC voltage application, the above-described electric power amount control is carried out.

An example of the power supply time ratio is shown in a table 1 below. The table 1 shows an embodiment in a first column, a discrimination threshold in a second column, a power supply time proportion of the heat generating element 54b1 in a third column, and a power supply time proportion of the heat generating element 54b3 in a fourth column. Here, the zone expresses a heat accumulation state of the fixing device 50. For example, a state in which the fixing device 50 is cool and a heat accumulation amount is small is Zone 1, and a state in which the fixing device 50 is hot and the heat accumulation amount is large is Zone 4. With an increasing value from the Zone 1 to the Zone 4, the heat accumulation amount of the fixing device 50 becomes larger. The CPU 94 performs discrimination of the zone by using an output value (detection result) of the fixing temperature sensor 59 provided in the fixing device 50. As shown in the table 1, the CPU 94 discriminates the zone as the Zone 1 when the detection result of the fixing temperature sensor 59 is 50° C. or less and as Zone 2 when the detection result of the fixing temperature sensor 59 is 100° C. or less (more than 50° C.). The CPU 94 discriminates the zone as Zone 3 when the detection result of the fixing temperature sensor 59 is 150° C. or less (more than 100° C.), and as the Zone 4 when the detection result of the fixing temperature sensor 59 is more than 150° C.

TABLE 1

| ZONE | THRESHOLD | 54b1 | 54b3 |
|---|---|---|---|
| 1 | 50° C. or less | 7 | 3 |
| 2 | 100° C. or less | 5 | 5 |
| 3 | 150° C. or less | 3 | 7 |
| 4 | more than 150° C. | 2 | 8 |

As shown in the table 1, with a larger zone value, in other words, with a larger heat accumulation amount of the fixing device 50, a proportion of a time in which the electric power is supplied to the heat generating element 54b1 becomes small (short). On the other hand, with the larger zone value, a proportion of a time in which the electric power is supplied to the heat generating element 54b3 becomes large (long). That is, the electric power controller 97 controls the switching device 57 so that a frequency of use of the heat generating element 54b3 becomes higher with the larger heat accumulation amount of the fixing device 50.

In the table 1, in the case of the Zone 1, it is shown that the power supply time ratio between the heat generating element 54b1 and the heat generating element 54b 3 is 7:3. The CPU 94 carries out the electric power amount control of the heat generating element 54b1 in a period of 7×8 half-waves (about 0.47 sec in the case of a frequency of 60 Hz). Then, the CPU 94 switches the heat generating element, to be controlled, from the heat generating element 54b1 to the heat generating element 54b3, and carries out the electric power amount control of the heat generating element 54b3 in a period of 3×8 half-waves (about 0.2 sec in the case of the frequency of 60 Hz). this switching operation is repeated under the above-described condition.

### Heater of Comparison Example 1

In order to confirm an effect of the embodiment 1, a conventional heater is employed in the comparison example 1 and is compared with the heater 54 in the embodiment 1. A heater 64 in the comparison example 1 is shown in FIG. 5, Part (a) of FIG. 5 is a schematic view showing a constitution of the heater 64, on which a heat generating element 64b is provided, as viewed from above. In the heater 64 in the comparison example 1, on a substrate 64a, heat generating elements 64b1, 64b2, and 64b3, a conductor 64c, and contacts 64d1 to 64d4 are formed, and thereon, in order to ensure insulation between each heat generating element 64b and the fixing film 51, a protective glass layer (not shown) is formed. A reference line a′ is a center line of the heat generating elements 64b1, 64b2, and 64b3 with respect to a longitudinal direction Dl′ and is also a center line of the sheet P, conveyed to the fixing device 50, with respect to a widthwise direction.

The heat generating element 64b1 is a heat generating element including heat generating elements 64b1a and 64b1b which each have a length L1′ of 222 mm in the longitudinal direction Dl′ and which are connected in parallel with each other. Specifically, with respect to a widthwise direction Ds'perpendicular to the longitudinal direction Dl′, the heat generating element 64b1 is provided in one end portion of the substrate 64a and the heat generating element 64b1 is provided in the other end portion of the substrate 64a. A synthetic electric resistance value of the two heat generating elements 64b1 and 64b1 is 10.7 Ω. The heat generating elements 64b1a and 64b1b are caused to generate heat by applying an AC voltage to between the contacts 64d1 and 64d4.

The heat generating element 64b 2 has a length L2′ of 188 mm in the longitudinal direction Dl′. An electric resistance value of the heat generating element 64b 2 is 20.5 Ω. The heat generating element 64b 2 is caused to generate heat by applying an AC voltage to between the contacts 64d2 and 64d2. The heat generating element 64b 3 has a length L3′ of 154 mm in the longitudinal direction Dl′. An electric resistance value of the heat generating element 64b 3 is 24 Ω. The heat generating element 64b3 is caused to generate heat by applying an AC voltage to between the contacts 64d3 and 64d1. The heat generating elements 664b2 and 64b3 are provided between the heat generating elements 64b1a and 64b1b. That is, with respect to the widthwise direction Ds′, on the substrate 64a, the heat generating element 64b1a, the heat generating element 64b2, the heat generating element 64b3, and the heat generating element 64b1 are disposed in this order.

Incidentally, part (b) of FIG. 5 is a schematic view showing a constitution of a power control circuit 68 of the heater 64. The power control circuit 68 includes, similarly as the power control circuit 58, the switching device 57, and the triacs 56a and 56b in order to supply the electric power from the AC power source 55 to the heater 64. Control of the switching device 57 and the triacs 56a and 56b are similar to the control of those of the power control circuit 58 and will be omitted from description.

### Details of Power Supply Time Ratio in Comparison Example 1

In a table 2 below, details of a power supply time ratio when the heat generating element 64b1 and the heat generating element 64b3 are used in the case where the A5-size sheet is passed.

TABLE 2

| | | |
|---|---|---|
| PSTR*¹ | ER*² [Ω] | HGEL*³ [mm] |

| ZONE | 64b1 | 64b3 | 64b1 | 64b3 | 64b1 | 64b3 |
|---|---|---|---|---|---|---|
| 1 | 7 | 3 | 10.7 | 24 | 222 | 154 |
| 2 | 5 | 5 | 10.7 | 24 | 222 | 154 |
| 3 | 3 | 7 | 10.7 | 24 | 222 | 154 |
| 4 | 2 | 8 | 10.7 | 24 | 222 | 154 |

| | MEP*⁴ | | TC*⁵ | AEP*⁶[W] | | EPD*⁷[W/[mm] | |
|---|---|---|---|---|---|---|---|
| ZONE | 64b1 | 64b3 | [° C.] | 64b1 | 64b3 | 64b1 | 64b3 |
| 1 | 1346 | 600 | 220 | 500 | 347 | 2.3 | 2.3 |
| 2 | 1346 | 600 | 215 | 450 | 312 | 2.0 | 2.0 |
| 3 | 1346 | 600 | 210 | 400 | 277 | 1.8 | 1.8 |
| 4 | 1346 | 600 | 205 | 350 | 243 | 1.6 | 1.6 |

*¹“PSTR” is the power supply time ratio.
*²“ER” is the electric resistance.
*³“HGEL” is the heat generating element length.
*⁴“MEP” is the maximum electric power.
*⁵“TC” is the temperature control.
*⁶“AEP” is the average electric power.
*⁷“EPD” is electric power density.

Also, in the comparison example 1, the power supply time ratio is different depending on the zone. In the table 2, the electric resistance value [Ω] and the heat generating element length [mm] of each of the heat generating elements 64b1 and 64b3 are also shown. For example, when the AC voltage is 120 V, values of the maximum electric power [W] of the heat generating elements 64b1 and 64b 3 are 1346 W and 600 W, respectively. With progress from Zone 1 to Zone 4, a temperature [°C] during temperature control becomes low. The average electric power [W] is an average (value) of electric power based on a result of measurement when sheets in a predetermined number are continuously passed through the fixing nip in each of the embodiments.

Here, in each of the embodiments, as regards the average electric power [W] when sheets of paper (for example, “Vitality” (75 g/cm²), manufactured by Xerox Corp.) are passed, in the case of the Zone 1, the average electric power during use of the heat generating element 64b1 is 500 W, and the average electric power during use of the heat generating element 64b 3 is 347 W. Although the values of the average electric power are 500 W and 347 W which are different from each other, an electric power amount per unit length (herein, referred to as the electric power density) [W/mm] is substantially the same value of 2.3 [W/mm] even when either of the heat generating elements 64b1 and 64b3 is used. Each of the average electric power and the electric power density becomes small in value with progress from the Zone 1 to the Zone 4, but even for either of the heat generating elements, the values of the electric power density are the same. The same applies to the Zones 2, 3, and 4.

### Electric Power Density in Sheet Passing Region and Non-Sheet-Passing Region in Comparison Example 1

By taking passing of the A5-size sheet as an example, the electric power density in the sheet passing region and the non-sheet-passing region is shown in a table 3 below. Here, an inside of a region of the heat generating element 64b3 (inside of a region of a length L3′) is the sheet passing region, and an outside of the region of the heat generating element 64b3 (outside of the region of the length L3′) is the non-sheet-passing region. Further, in the table 3, the power supply time ratio is also shown.

TABLE 3

| | |
|---|---|
| PSTR*¹ | EPD*² [W/mm] |

| ZONE | 64b1 | 64b3 | SPR | NSPR |
|---|---|---|---|---|
| 1 | 7 | 3 | 2.3 | 1.6 |
| 2 | 5 | 5 | 2.0 | 1.0 |
| 3 | 3 | 7 | 1.8 | 0.5 |
| 4 | 2 | 8 | 1.6 | 0.3 |

*¹“PSTR” is the power supply time ratio.
*²“EPD” is the electric power density.

As described above using the table 2, in the case of the Zone 2, the electric power density of each of the heat generating elements 64b1 and 64b3 formed in the sheet passing region is the same value of 2.3 [W/mm]. In the case where the power supply time ratio is 7:3, the electric power density in the sheet passing region is 2.3 [W/mm]×0.7+2.3 [W/mm]×0.3=2.3 [W/mm]. Also, in the cases of the Zones 2, 3, and 4, the electric power density in the sheet passing region is calculated by the same method.

On the other hand, during use of the heat generating element 64b3 narrow in width, the electric power is not supplied to the non-sheet-passing region. In the case of the Zone 1, the power supply time ratio is 7:3, so that the electric power is supplied to the non-sheet-passing region only in a time which is 70% of an entire time. The electric power density in the non-sheet-passing region is 2.3 [W/mm]×0.7+0 [W/mm]×0.3=1.6 [W/mm]. When the electric power density in each of the Zones 2, 3, and 4 is also calculated by the same method, a result thereof is as shown in the table 3.

### Embodiment 1

Similarly as the comparison example 1, details of the power supply time ratio control and the electric power density in the sheet passing region and the non-sheet-passing region in the embodiment 1 will be described. In the embodiment 1, the heat generating element 54b shown in FIG. 4 is incorporated into the fixing device 50. The heat generating element 54b3 used when the A5-size sheet is passed has a series pattern of the heat generating elements 54b3b, 54b3a, 54b3c, and is largely different in constitution from the heat generating element 64b3 in the comparison example 1. Also, the heat generating element 54b2 used when the B5-size sheet is passed has a pattern in which the plurality of heat generating elements 54b2, 54b2a, and 54b2c are connected in series with each other similarly as the heat generating element 54b3, and is largely different in constitution from the heat generating element 64b2 in the comparison example 1. The embodiment 1 will be described by taking the case where the A5-size sheet is passed, i.e., the case where the heat generating element 54b3 is used, as an example.

### Details of Power Supply Time Ratio Control in Embodiment 1

Details of the power supply time ratio control in the case where the A5-size sheet is passed, i.e., when the heat generating element 54b1 and the heat generating element 54b3 are used will be described. In a table 4 below, the power supply time ratio, the electric resistance [Ω], and the heat generating element length [mm] in each zone are shown. The power supply time ratio was made the same as the power supply time ratio in the comparison example 1.

TABLE 4

| | PSTR*¹ | | | ER*² [Ω] | | | |
|---|---|---|---|---|---|---|---|
| ZONE | 54b1 | 54b3 | 54b1 | 54b3 | 54b3b | 54b3a | 54b3c |
| 1 | 7 | 3 | 10.7 | 22.1 | 0.9 | 20.3 | 0.9 |
| 2 | 5 | 5 | 10.7 | 22.1 | 0.9 | 20.3 | 0.9 |
| 3 | 3 | 7 | 10.7 | 22.1 | 0.9 | 20.3 | 0.9 |
| 4 | 2 | 8 | 10.7 | 22.1 | 0.9 | 20.3 | 0.9 |

HGEL*³ [mm]

| ZONE | 54b1 | 54b3b | 54b3a | 54b3c |
|---|---|---|---|---|
| 1 | 222 | 34 | 154 | 34 |
| 2 | 222 | 34 | 154 | 34 |
| 3 | 222 | 34 | 154 | 34 |
| 4 | 222 | 34 | 154 | 34 |

*¹“PSTR” is the power supply time ratio.
*²“ER” is the electric resistance.
*³“HGEL” is the heat generating element length.

Further, in a table 5 below, a relationship between the zones, the power supply time ratio, the maximum electric power, and the average electric power when the heat generating elements 54b1 and 54b3 are used.

TABLE 5

| | PSTR*¹ | | | MEP*² [W] | | | |
|---|---|---|---|---|---|---|---|
| ZONE | 54b1 | 54b3 | 54b1 | 54b3 | 54b3b | 54b3a | 54b3c |
| 1 | 7 | 3 | 1346 | 652 | 26.4 | 598.9 | 26.4 |
| 2 | 5 | 5 | 1346 | 652 | 26.4 | 598.9 | 26.4 |
| 3 | 3 | 7 | 1346 | 652 | 26.4 | 598.9 | 26.4 |
| 4 | 2 | 8 | 1346 | 652 | 26.4 | 598.9 | 26.4 |

AEP*³ [W]

| ZONE | 54b1 | 54b3 | 54b3b | 54b3a | 54b3c |
|---|---|---|---|---|---|
| 1 | 500 | 378 | 15.3 | 347 | 15.3 |
| 2 | 450 | 339 | 13.8 | 311 | 13.8 |
| 3 | 400 | 300 | 12.2 | 275 | 12.2 |
| 4 | 350 | 264 | 10.7 | 243 | 10.7 |

*¹“PSTR” is the power supply time ratio.
*²“MEP” is the maximum electric power.
*³“AEP” is the average electric power.

The electric resistance values and the heat generating element lengths of the heat generating elements 54b1 and 54b3 are as shown in the table 4, and values of the maximum electric power of the heat generating elements 54b1 and 54b 3 at the AC voltage of 120 V are 1346 W and 652 W, respectively. Values of the maximum electric power of the heat generating elements 54b3b, 54b3a, and 54b3c are about 26 W, about 600 W, and about 26 W, respectively. The heat generating element 65b3 in the comparison example 1 is 154 mm in heat generating element length and is about 600 W in maximum electric power. The heat generating element 54b3a in the embodiment 1 is also 154 mm in heat generating element length, and the electric resistance value thereof is set so that the maximum electric power of this heat generating element 54b3a becomes about 600 W which is the same as the maximum electric power of the heat generating element 64b3 in the comparison example 1. That is, in the case where the AC voltage values are the same, values of the electric power density of the heat generating elements 64b3 and 54b3a are the same. The same electric power density of the heat generating element 64b3 and the heat generating element 54b3a and the heat generating element 54b3a is intended to uniformize an amount of deformation of the substrate 54a when the electric power is supplied to these heat generating elements, to substantially the same amount.

In this condition, in the Zone 1, the average electric power during use of the heat generating element 54b1 is 500 W, and average electric power during use of the heat generating element 54b 3 is 378 W. Further, the heat generating element 54b3a is 347 W in average electric power, and each of the heat generating elements 54b3c and 54b3b is 15.3 W in average electric power. Incidentally, also in the case of the embodiment 1, the average electric power becomes lower in value with progress from the Zone 1 to the Zone 4.

From the average electric power and the heat generating element length, the electric power density in each of the Zones 1 to 4 is calculated, and a result thereof is shown in a table 6.

TABLE 6

| | PSTR*¹ | | | EPD*² [W/mm] | | |
|---|---|---|---|---|---|---|
| Zone | 54b1 | 54b3 | 54b1 | 54b3b | 54b3a | 54b3c |
| 1 | 7 | 3 | 2.3 | 0.45 | 2.3 | 0.45 |
| 2 | 5 | 5 | 2.0 | 0.40 | 2.0 | 0.40 |
| 3 | 3 | 7 | 1.8 | 0.36 | 1.8 | 0.36 |
| 4 | 2 | 8 | 1.6 | 0.32 | 1.6 | 0.32 |

*¹“PSTR” is the power supply time ratio.
*²“EPD” is the electric power density.

The heat generating element 54b1 is 500 W/222 mm 32 2.3 [W/mm] in electric power density, and the heat generating element 54b3a is 347 W/154 mm=2.3 [W/mm] in electric power density. Each of the heat generating elements 54b3c and 54b3b is 15.3 W/34 mm=0.45 [W/mm] in electric power density. In the heat generating element 54b3, the heat generating element 54b3a in the central portion is the same in electric power density as that in the central portion, and the electric power density is lower in each of the end portions than in the central portion. The same also applies to other Zones 2 to 4.

### Electric Power Density in Sheet Passing Region and Non-Sheet-Passing Region in Embodiment 1

Values of the electric power density in the sheet passing region and the non-sheet-passing region in the embodiment 1 are shown in a table 7 below by taking the sheet passing of the A5-size sheet as an example. Incidentally, in the table 7, the power supply time ratio and the electric power density in the embodiment 1 described with reference to the table 6 and the electric power density in the sheet passing region and the non-sheet-passing region in the comparison example 1 (heat generating elements 64b1 and 64b3) described with reference to the table 3 are also shown.

TABLE 7

| | PSTR*¹ | | | EPD*² [W/mm] | | |
|---|---|---|---|---|---|---|
| ZONE | 54b1 | 54b3 | 54b1 | 54b3b | 54b3a | 54b3c |
| 1 | 7 | 3 | 2.3 | 0.45 | 2.3 | 0.45 |
| 2 | 5 | 5 | 2.0 | 0.40 | 2.0 | 0.40 |
| 3 | 3 | 7 | 1.8 | 0.36 | 1.8 | 0.36 |
| 4 | 2 | 8 | 1.6 | 0.32 | 1.6 | 0.32 |

EPD*⁷[W/[mm]

| ZONE | SPR | NSPR | SPR | NSPR |
|---|---|---|---|---|
| 1 | 2.3 | 1.7 | 2.3 | 1.6 |
| 2 | 2.0 | 1.2 | 2.0 | 1.0 |
| 3 | 1.8 | 0.8 | 1.8 | 0.5 |
| 4 | 1.6 | 0.6 | 1.6 | 0.3 |

*¹“PSTR” is the power supply time ratio.
*²“EPD” is the electric power density. “SPR” is the sheet passing region. “NSPR” is the non-sheet-passing region.

Here, an inside of a region of the heat generating element 54b3a (inside of the length L3) is the sheet passing region, and an outside of the region of the heat generating element 54b3a (outside of the length L3) is the non-sheet-passing region. In the case of the Zone 1, the electric power density of the heat generating element 54b1 positioned in the sheet passing region and the electric power density of the heat generating element 54b3 similarly positioned in the sheet passing region are the same value of 2.3 [W/mm]. In the case where the power supply time ratio is 7:3, the electric power density is calculated as 2.3 [W/mm]×0.7+2.3 [W/mm]×0.3=2.3 [W/mm]. Also, in the Zones 2, 3, and 4, the electric power density is calculated by the same method.

On the other hand, portions capable of supplying the electric power to the non-sheet-passing region are end portions of the heat generating element 54b1, and the heat generating elements 54b3b and 54b3c in end portions of the heat generating element 54b3. In the case of the Zone 1, the power supply time ratio is 7:3. To the heat generating element 54b1, the electric power is supplied in a time which is 70% of an entire time. To each of the heat generating elements 54b3b and 54b3c, the electric power is supplied in a time which is 30 % of the entire time. Therefore, the electric power density is calculated as 2.3 [W/mm]×0.7+0.45 [W/mm]×0.3=about 1.7 [W/mm]. Also, in the Zones 2, 3, and 4, the electric power density is calculated by the same method.

### Comparison Between Embodiment 1 and Comparison Example 1

Values of the electric power density in the sheet passing region and the non-sheet-passing region in the comparison example 1 and the embodiment 1 will be compared with each other. The values of the electric power density in the sheet passing region are the same, but the values of the electric power density in the non-sheet-passing region are different from each other. In either of the embodiments, the electric power density in the non-sheet-passing region is higher in the embodiment 1 than in the comparison example 1, so that the non-sheet-passing region reaches a high temperature earlier in the embodiment 1 than in the comparison example 1. Therefore, in the embodiment 1, the power supply time ratio is set to values different from those in the comparison example 1, so that the electric power density which is the same as that in the non-sheet-passing region in the embodiment 1 is realized.

In a table 8, a newly set power supply time ratio and the electric power density thereat are shown. Here, in the table 7, a sum of a former term and a latter term of the power supply time ratio was made constant irrespective of the zones. That is, in the table 7, the above sum was made 10 which is a constant value. On the other hand, in the table 8, the sum is changed depending on the zones. For example, the sum is 11, 13, 23, and 10 in the Zone 1, the Zone 2, the Zone 3, and the Zone 4, respectively

TABLE 8

| | PSTR*¹ | | | EPD*² [W/mm] | | |
|---|---|---|---|---|---|---|
| ZONE | 54b1 | 54b3 | 54b1 | 54b3b | 54b3a | 54b3c |
| 1 | 7 | 4 | 2.3 | 0.45 | 2.3 | 0.45 |
| 2 | 5 | 8 | 2.0 | 0.40 | 2.0 | 0.40 |
| 3 | 3 | 20 | 1.8 | 0.36 | 1.8 | 0.36 |
| 4 | 0 | 10 | 1.6 | 0.32 | 1.6 | 0.32 |

EPD*⁷[W/[mm]

| ZONE | SPR | NSPR | SPR | NSPR |
|---|---|---|---|---|
| 1 | 2.3 | 1.6 | 2.3 | 1.6 |
| 2 | 2.0 | 1.0 | 2.0 | 1.0 |
| 3 | 1.8 | 0.5 | 1.8 | 0.5 |
| 4 | 1.6 | 0.3 | 1.6 | 0.3 |

*¹“PSTR” is the power supply time ratio.
*²“EPD” is the electric power density. “SPR” is the sheet passing region. “NSPR” is the non-sheet-passing region.

The power supply time ratio was changed from 7:3 to 7:4 in the Zone 1, 5:5 to 5:8 in the Zone 2, 3:7 to 3:20 in the Zone 3, and 2:8 to 0:10 in the Zone 4. That is, the electric power controller 97 changes a ratio between a time in which the electric power is supplied to the heat generating elements 54b1a and 53b1b and a time in which the electric power is supplied to the heat generating element 54b3, depending on a heat accumulation amount of the fixing device 50. For example, the electric power density in the non-sheet-passing region in the Zone 1 is calculated as 2.3 [W/mm]×7/(7+4)+0.45 [W/mm]×4/(7+4)=about 1.6 [W/mm]. Also, in the Zones 2, 3, and 4, the calculation is performed by the same method.

By this, also in the embodiment 1, values of the average electric power density in the sheet passing region and the non-sheet-passing region can be made the same as values in the comparison example 1, so that a heat generation distribution in the sheet passing region and the non-sheet-passing region can be controlled so as to becomes the same between the embodiment 1 and the comparison example 1. Therefore, such an effect that a conventional non-sheet-passing region does not reach a high temperature can also be achieved in the embodiment 1.

### Effect of Embodiment 1

Hereinabove, the power supply time ratio, the electric power density, and the like using the heat generating element 54b in the embodiment 1 were described. An effect obtained by the embodiment 1 is organized and described hereinafter. In a table 9, the power supply time ratios in the embodiment 1 and the comparison example 1 are shown.

TABLE 9

| | |
|---|---|
| EMB. 1 | COMP. EX. 1 |
| PSTR*¹ | PSTR*¹ |

| ZONE | 54b1 | 54b3 | 64b1 | 64b3 |
|---|---|---|---|---|
| 1 | 7 | 4 | 7 | 3 |
| 2 | 5 | 8 | 5 | 5 |
| 3 | 3 | 20 | 3 | 7 |
| 4 | 0 | 10 | 2 | 8 |

*¹“PSTR” is the power supply time ratio.

As shown in the table 9, in the embodiment 1, a switching frequency of the heat generating elements is lower than in the comparison example 1. This is readily understood in the case of the Zone 4. In the Zone 4, the power supply time ratio of the heat generating element 54b1 is “0”, and there is need to switch the heat generating element 54b1 in control, and therefore, a current amount fluctuation causing flicker phenomenon does not occur. Although the current amount fluctuation cannot be made zero in the Zones 2, 3, and 4, a switching frequency of the heat generating element 54b can be made lower than in the comparison example 1, so that the lower switching frequency leads to suppression of the flicker phenomenon.

Description thereof will be made by taking the Zone 3 as an example. A minimum unit of the power supply time ratio is 8 half-waves. The 8 half-waves when the frequency of the AC power source 55 is 60 Hz is about 0.067 second. In the comparison example 1, switching control is carried out at a time ratio between 0.2 second=3×8 half-waves for the heat generating element 64b1 and about 0.47 second=7×8 half-waves for the heat generating element 64b 3. On the other hand, in the embodiment 1, switching control is carried out at a time ratio between 0.2 second=3×8 half-waves for the heat generating element 54b1 and about 1.3 seconds=20×8 half-waves for the heat generating element 54b 3. That is, in the embodiment 1, the switching frequency is low.

In a table 10, electric resistances [Ω] and maximum current amounts [A] of heat generating elements and maximum current amount differences in the comparison example 1 and the embodiment 1 are shown.

TABLE 10

| | |
|---|---|
| ER*¹[Ω] | MCA*²[A] |

| | 64b1 | 64b3 | 64b1 | 64b3 | MCAD*³ |
|---|---|---|---|---|---|
| COMP. EX. 1 | 10.7 | 24 | 11.2 | 5.0 | 6.2 |
| | 54b1 | 54b3 | 54b1 | 54b3 | |
| EMB. 1 | 10.7 | 22.1 | 11.2 | 5.4 | 5.8 |

*¹“ER” is the electric resistance.
*²“MCA” is the maximum current amount.
*³“MCAD” is the maximum current amount difference.

Electric resistance values of the heat generating elements 54b1 and 54b3 in the comparison example 1 are 10.7 Ω and 24 Ω, respectively, and a difference therebetween is 13.3 Ω. Electric resistance values of the heat generating elements 54b1 and 54b 3 are 10.7 Ω (synthetic electric resistance value R1) and 22.1 Ω (electric resistance value R2), respectively, so that the synthetic electric resistance value R1 of the heat generating element 54b1 is lower than the electric resistance value R2 of the heat generating element 54b3 (R1>R2), and a difference therebetween is 11.4 Ω. That is, in the embodiment 1, the electric resistance value difference is smaller than in the comparison example 1.

The maximum current amount of each heat generating element in the table 10, the AC voltage is calculated as 120 V. The maximum current amounts of the heat generating elements 64b1 and 64b3 is the comparison example 1 are 11.2 A and 5.0 A, respectively. A difference therebetween is 6.2 A. The maximum current amounts of the heat generating elements 54b1 and 54b3 in the embodiment 1 are 11.2 A and 5.4 A, respectively. A difference therebetween is 5.8 A. That is, in the embodiment 1, the maximum current amount difference between the heat generating element is smaller than in the comparison example 1. That is, in the embodiment 1, a fluctuation in maximum current amount during switching of the heat generating element 54b can be reduced, so that flicker phenomenon suppressing capacity is high.

As described above, the heater 54 in the embodiment 1 includes the first heat generating element and the second heat generating element which are low in electric resistance value and large in maximum heat generation amount during parallel constitution. Further, the heater 54 includes the third heat generating element which is disposed between the first heat generating element and the second heat generating element with respect to the widthwise direction and which is high in electric resistance value and small in maximum heat generation amount. In addition, the third heat generating element includes a central portion short in length than each of the first heat generating element and the second heat generating element with respect to the longitudinal direction, and to each of opposite ends of the central portion, a heat generating region lower in electric resistance value than the central portion is connected in series with the central portion. By this, when the sheet narrow in width is passed, a switching frequency of the heat generating element is reduced, so that a difference in current amount fluctuation during switching of the heat generating element can be reduced. In the embodiment 1, compare with the conventional example, the number of the heat generating elements and the heat generation density are not changed, so that it is possible to reduce an occurrence of the flicker phenomenon while realizing compatibility of downsizing and high productivity which are advantages of the conventional example.

Incidentally, in the embodiment 1, the case where the A4-size sheet is passed was described, but in the case where the B5-size sheet is passed, the heat generating elements 54b1 and 54b2 are used and controlled in accordance with a way of thinking and a calculating method which are described in the embodiment 1, so that a similar effect can be realized. That is, the heat generating element 54b2 may also be constituted so as to function as the third heat generating element. In this case, the heat generating element 54b2c as a third portion, the heat generating element 54b2 as a first portion, and the heat generating element 54b2b as a second portion are connected in series with each other in this order. A way of thinking and a calculating method in the case where the heat generating element 54b2 is used are the same as those in the embodiment 1, and therefore, described thereof will be omitted.

Further, the heat generating element 54b1a and the heat generating element 54b1b which are disposed on the heater 54 in the embodiment 1 are constituted so as to have the same length L1=222 mm in the longitudinal direction Dl. However, for example, even in a constitution in which suppression of the temperature rise of the non-sheet-passing region when the A4-size sheet is passed is expected by causing the heat generating elements 54b1a and 54b1b to have lengths of 222 mm and 220 mm, respectively, a similar effect can be expected. Even in a constitution in which a temperature of an end portion with respect to the longitudinal direction when an LTR-size sheet is passed is increased by causing the heat generating elements 54b1a and 54b1b to have lengths of 222 mm and 224 mm, respectively, a similar effect can be expected. That is, the first heat generating element and the second heat generating element may have lengths in the longitudinal direction, which are the same or different from each other.

As described above, according to the embodiment 1, the flicker phenomenon can be suppressed while realizing the downsizing and improving the productivity of the printing.

### Embodiment 2

In an embodiment 2, a method of further reducing a fluctuation amount of the maximum current amount when the heat generating element is switched will be described. Description of the same contents such as an image forming apparatus, a fixing device, various pieces of control, and the like described in the embodiment 1 will be omitted.

### Detailed Description of Heat Generating Elements of Heater 74

The heat generating element 74b of the heater 74 is a feature of the embodiment 2. Details of the heat generating element 74b of the heater 74 will be described using part (a) of FIG. 6. Part (a) of FIG. 6 is a schematic view showing a constitution of the heater 74 when the heater 74 on which the heat generating element 74b is disposed is viewed from above. On the substrate 74a, heat generating elements 74b1 and 74b2 as a first heat generating element, a heat generating element 74b3, as a second heat generating element, a conductor 74c, and contacts 74d1 to 74d4 are formed. Further, thereon, in order to ensure insulation between each heat generating element 74b and the fixing film 51, the protective glass layer 74e is formed. A reference line a is a center line of the heat generating elements 74b1, 74b2, and 74b3 with respect to a longitudinal direction Dl and is also a center line of the sheet P, conveyed to the fixing device 50, with respect to a longitudinal direction of the sheet P.

The heat generating element 74b1 is a heat generating element including heat generating elements 74b1a as and 74b1 which have a length L4 of 222 mm in the longitudinal direction D0 and which are connected in parallel with each other. Specifically, with respect to a widthwise direction (short direction) Ds perpendicular to the longitudinal direction Dl, the heat generating element 74b1ais provided in one end portion of the substrate 74a, and the heat generating element 74b1 is provided in the other end portion of the substrate 74a. A synthetic electric resistance value R1 of the two heat generating elements 74b1a and 74b1b is 10.7 Ω. The heat generating element 74b1 is caused to generate heat by applying an AC voltage to between the contact 74d2 and the contact 74d4.

The heat generating element 74b2 is an heat generating element including heat generating elements 74b2c, 74b2a, and 74b2b which are connected in series with each other in this order. The heat generating element 74b2c has a length of 27 mm in the longitudinal direction Dl, the heat generating element 74b2a has a length L5 of 188 mm in the longitudinal direction Dl, and the heat generating element 74b2b has a length of 27 mm in the longitudinal direction Dl, and a film thickness of each of these heat generating elements is 10 μm. An electric resistance value of the heat generating element 74b2a is 18.3 Ω, and an electric resistance value of each of the heat generating elements 74b2b and 74b2cis 0.53 Ω. The heat generating element 74b 2 is caused to generate heat by applying an AC voltage to between the contact 73d3 and the contact 74d2.

When with respect to the longitudinal direction Dl, an electric power amount per unit length is defined as a heat generation density, a ratio of heat generation density of the heat generating elements 74b2c and 74b2b to the heat generation density of the heat generating element 74b2a is 5:1. In order to realize the heat generation density, there is a need to determine an electric resistivity ρ2a of the heat generating element 74b2a and electric resistivities ρ2c and ρ2b of the heat generating elements 74b2c and 74b2b. A relationship between the electric resistivity ρ2a, the electric resistivity ρ2b, and the electric resistivity ρ2c is ρ2a=⅕×ρ2c=⅕×ρ2b.

In order to make a heat generation ratio between the sheet passing region and the non-sheet-passing region substantially the same between the case where heat generating elements 64b1 and 64b2 are used in a power supply time ratio of 2:8 in a comparison example 1 and the case where only the heat generating element 74b2 is used in the embodiment 2, a heat generation density ratio is designed to 1:5. Incidentally, when voltages having the same voltage value are applied to the heat generating element 74b2 in the embodiment 2 and the heat generating element 64b2 in the comparison example 1, electric resistance values are designed so that electric power values of the heat generating element 64b2 and the heat generating element 74b2 coincide with each other. Heat generating element lengths of the heat generating elements 64b2 and 74b2 are the same, and heat generation densities thereof when the same voltage is applied thereto are also the same.

The heat generating element 74b3 is an heat generating element including heat generating elements 74b3c, 74b3a, and 74b3b which are connected in series with each other in this order. The heat generating element 74b3c has a length of 44 mm in the longitudinal direction Dl, the heat generating element 74b3a has a length L6 of 154 mm in the longitudinal direction Dl, and the heat generating element 74b3b has a length of 44 mm in the longitudinal direction Dl, and a film thickness of each of these heat generating elements is 10 μm. An electric resistance R2 value of the heat generating element 74b3a is 19.2 Ω, and an electric resistance value of each of the heat generating elements 74b3b and 74b3c is 1.1 Ω. The heat generating element 74b 3 is caused to generate heat by applying an AC voltage to between the contact 74d3 and the contact 74d1. The heat generating elements 74b2 and 74b3 are provided between the heat generating element 74b1a and the heat generating element 74b1b with respect to the widthwise direction Ds. That is, with respect to the widthwise direction Ds, on the substrate 74a, the heat generating elements 74b1a, 74b2, 74b3, and 74b1b are disposed in this order.

Incidentally, part (b) of FIG. 6 is a schematic view showing a constitution of a power control circuit 78 of the heater 74. The power control circuit 78 includes, similarly as the power control circuit 58, the switching device 57, and the triacs 56a and 56b in order to supply the electric power from the AC power source 55 to the heater 64. Control of the switching device 57 and the triacs 56a and 56b are similar to the control of those of the power control circuit 58 and will be omitted from description.

When with respect to the longitudinal direction Dl, an electric power amount per unit length is defined as a heat generation density, a ratio of heat generation density of the heat generating elements 74b3c and 74b3b to the heat generation density of the heat generating element 74b3a is 5:1. In order to realize the heat generation density, there is a need to determine an electric resistivity ρ3a of the heat generating element 74b3a and electric resistivities ρ3c and ρ3b of the heat generating elements 74b3c and 74b3b. A relationship between the electric resistivity ρ3a, the electric resistivity ρ3b, and the electric resistivity ρ3c is ρ3a=⅕×ρ3c=⅕×ρ3b.

In order to make a heat generation ratio between the sheet passing region and the non-sheet-passing region substantially the same between the case where heat generating elements 64b1 and 64b3 are used in a power supply time ratio of 2:8 in a comparison example 1 described later and the case where only the heat generating element 74b3 is used in the embodiment 2, a heat generation density ratio is designed to 1:5. Incidentally, when voltages having the same voltage value are applied to the heat generating element 74b3 in the embodiment 2 and the heat generating element 64b3 in the comparison example 1, electric resistance values are designed so that electric power values of the heat generating element 64b3 and the heat generating element 74b3 coincide with each other. Heat generating element lengths of the heat generating elements 64b3 and 74b3 are the same, and heat generation densities thereof when the same voltage is applied thereto are also the same.

Each of the heat generating element 74b2 and the heat generating element 74b3 in the embodiment 2 is a single heat generating element such that three heat generating elements different in resistance value are connected in series with each other. Each of the heat generating elements 54b1, 54b2, and 54b 3 in the embodiment 1 has the length of 222 mm in the longitudinal direction D1. On the other hand, as regards the heat generating element 74b in the embodiment 2, the length in the longitudinal direction Dl is 222 mm for the heat generating element 74b 1, and 242 mm (L7) for the heat generating element 74b 2 and the heat generating element 74b3, so that these lengths in the longitudinal direction Dl are different from each other. Specifically, the length (L7) of each of the heat generating elements 74b2 and 74b3 in the longitudinal direction Dl is longer than the length (L4) of the heat generating element 74b1 in the longitudinal direction Dl (L7>L4). By this feature, in the embodiment 2, the flicker phenomenon can be further suppressed.

Incidentally, depending on the sheet width of the sheet passed, the heat generating element used is different. In the case of the A4-size sheet, the heat generating element 74b1 with the length corresponding to the width of the A4-size sheet is used. In the case of the B5-size sheet, the heat generating element 74b1 or the heat generating element 74b2 with the length corresponding to the width of the B5-size sheet are alternately used in a switching manner. In the case of the 5-size sheet, the heat generating element 74b1 or the heat generating element 74b3 with the length corresponding to the width of the A4-size sheet are alternately used in a switching manner.

### Details of Power Supply Time Ratio Control in Embodiment 3

Details of the power supply time ratio control in the case where the A5-size sheet is passed, i.e., when the heat generating element 74b1 and the heat generating element 74b3 are used will be described. In a table 11 below, the power supply time ratio, the electric resistance, and the heat generating element length in each zone are shown.

TABLE 11

| | PSTR*¹ | | | ER*² [Ω] | | | |
|---|---|---|---|---|---|---|---|
| ZONE | 74b1 | 74b3 | 74b1 | 74b3 | 74b3b | 74b3a | 74b3c |
| 1 | 7 | 4 | 10.7 | 21.4 | 1.1 | 19.2 | 1.1 |
| 2 | 5 | 8 | 10.7 | 21.4 | 1.1 | 19.2 | 1.1 |
| 3 | 3 | 20 | 10.7 | 21.4 | 1.1 | 19.2 | 1.1 |
| 4 | 0 | 10 | 10.7 | 21.4 | 1.1 | 19.2 | 1.1 |

HGEL*³ [mm]

| ZONE | 74b1 | 74b3b | 74b3a | 74b3c |
|---|---|---|---|---|
| 1 | 222 | 44 | 154 | 44 |
| 2 | 222 | 44 | 154 | 44 |
| 3 | 222 | 44 | 154 | 44 |
| 4 | 222 | 44 | 154 | 44 |

*¹“PSTR” is the power supply time ratio.
*²“ER” is the electric resistance.
*³“HGEL” is the heat generating element length.

The power supply time ratio is the same as the power supply time ratio in the embodiment 1. The maximum electric power is calculated from the electric resistance value in the table 11, and the average electric power when the paper (“Vitality” (75 g/cm²), manufactured by Xerox Corp.) was passed is measured, and resultant values are shown in a table 12.

TABLE 12

| ZONE | 74b1 | 74b3 | 74b3b | 74b3a | 74b3c |
|---|---|---|---|---|---|
| | MEP*² [W] | | | | |
| 1 | 1346 | 673 | 34.4 | 604.7 | 34.4 |
| 2 | 1346 | 673 | 34.4 | 604.7 | 34.4 |
| 3 | 1346 | 673 | 34.4 | 604.7 | 34.4 |
| 4 | 1346 | 673 | 34.4 | 604.7 | 34.4 |
| | AEP*² [W] | | | | |
| 1 | 500 | 391 | 19.9 | 351 | 19.9 |
| 2 | 450 | 350 | 17.9 | 314 | 17.9 |
| 3 | 400 | 310 | 15.8 | 278 | 15.8 |
| 4 | 350 | 273 | 13.9 | 245 | 13.9 |

*1: “MEP” is the maximum electric power.
*²“AEP” is the average electric power.

The electric resistance values and the heat generating element lengths of the respective heat generating elements are as shown in the table 11, and at the AC voltage of 120 V, values of the maximum electric power of the heat generating elements 74b1 and 74b 3 are 1346 W and 673 W, respectively. Values of the maximum electric power of the heat generating elements 74b3b, 74b3a, and 74b3c are 34.4 W, 604.7 W, and 34.4 W, respectively. Values of the maximum electric power of the heat generating elements 64b1 and 64b2 shown in the comparison example 1 are 1346 W and 600 W, and therefore, compared with the comparison example 1, in the embodiment 2, a difference in maximum electric power between the two heat generating elements is small.

From the average electric power and the heat generating element length, the electric power density in each of the Zones 1 to 4 is calculated, and a result thereof is shown in a table 13.

TABLE 13

| | PSTR*¹ | | | EPD*² [W/mm] | | |
|---|---|---|---|---|---|---|
| ZONE | 74b1 | 74b3 | 74B1 | 74b3b | 74b3a | 74b3c |
| 1 | 7 | 4 | 2.3 | 0.45 | 2.3 | 0.45 |
| 2 | 5 | 8 | 2.0 | 0.41 | 2.0 | 0.41 |
| 3 | 3 | 20 | 1.8 | 0.36 | 1.8 | 0.36 |
| 4 | 0 | 10 | 1.6 | 0.32 | 1.6 | 0.32 |

*¹“PSTR” is the power supply time ratio.
*²“EPD” is the electric power density.

In the Zone 1, the electric power density of the heat generating element 74b1 is 500 W/222 W=2.3 [W/mm]. The electric power density of the heat generating element 74b3a is 351 W/154 mm=2.3 [W/mm]. The electric power density of each of the heat generating elements 74b3c and 74b3b is 19.9 W/44 mm=0.45 [W/mm]. In the case of the embodiment 1, the electric power density of each of the heat generating elements 54b1 and 54b3a is 2.3 [W/mm], and the electric power density of each of the heat generating elements 54b3c and 54b3b is 0.45 [W/mm] (Table 6), so that it is possible to confirm that in the embodiment 1 and the embodiment 2, the electric power densities with respect to the longitudinal direction Dl are substantially the same. That is, also in the constitution of the embodiment 2, it is possible to realize a heat generation distribution with respect to the longitudinal direction Dl, which is substantially the same as the heat generation distribution in the embodiment 1.

### Electric Power Density in Sheet Passing Region and Non-Sheet-Passing Region in Embodiment 2

In a table 14, values of the power supply time ratio and the electric power density thereat are shown.

TABLE 14

| | PSTR*¹ | | | EPD*² [W/mm] | | |
|---|---|---|---|---|---|---|
| ZONE | 74b1 | 74b3 | 74b1 | 74b3b | 74b3a | 74b3c |
| 1 | 7 | 4 | 2.3 | 0.45 | 2.3 | 0.45 |
| 2 | 5 | 8 | 2.0 | 0.41 | 2.0 | 0.41 |
| 3 | 3 | 20 | 1.8 | 0.36 | 1.8 | 0.36 |
| 4 | 0 | 10 | 1.6 | 0.32 | 1.6 | 0.32 |

EPD*⁷[W/[mm]

| ZONE | SPR | NSPR | SPR | NSPR |
|---|---|---|---|---|
| 1 | 2.3 | 1.6 | 2.3 | 1.6 |
| 2 | 2.0 | 1.0 | 2.0 | 1.0 |
| 3 | 1.8 | 0.5 | 1.8 | 0.5 |
| 4 | 1.6 | 0.3 | 1.6 | 0.3 |

*¹“PSTR” is the power supply time ratio.
*²“EPD” is the electric power density. “SPR” is the sheet passing region. “NSPR” is the non-sheet-passing region.

A calculating method is similar to the calculating method in the embodiment 1, and therefore, description thereof will be omitted. The power supply time ratio is set to that the values of the electric power density in the sheet passing region and the non-sheet-passing region are equal to those in the comparison example 1. By this, a use time of the heat generating element 74b3 can be prolonged.

### Effect of Embodiment 2

An effect of the embodiment 2 will be organized and described. In a table 15, the power supply time ratios in the embodiment 2 and the comparison example 1 are shown.

TABLE 15

| | |
|---|---|
| EMB. 2 | COMP. EX. 1 |
| PSTR*¹ | PSTR*¹ |

| ZONE | 74b1 | 74b3 | 64b1 | 64b3 |
|---|---|---|---|---|
| 1 | 7 | 4 | 7 | 3 |
| 2 | 5 | 8 | 5 | 5 |
| 3 | 3 | 20 | 3 | 7 |
| 4 | 0 | 10 | 2 | 8 |

*¹“PSTR” is the power supply time ratio.

Similarly as in the embodiment 1, in the embodiment 2, a switching frequency of the heat generating elements 74b1 and 74b3 is low. In the case of the Zone 4, a current amount fluctuation causing the flicker phenomenon does not occur. In the case of the Zones 1, 2, and 3, although the current amount fluctuation cannot be made zero, a frequency thereof can be lowered, so that it is possible to suppress the flicker phenomenon.

In a table 16, electric resistances [Ω] and maximum current amounts [A] of heat generating elements and maximum current amount differences in the comparison example 1 and the embodiment 2 are shown.

TABLE 16

| | |
|---|---|
| ER*¹[Ω] | MCA*²[A] |

| | 64b1 | 64b3 | 64b1 | 64b3 | MCAD*³ |
|---|---|---|---|---|---|
| COMP. EX. 1 | 10.7 | 24 | 11.2 | 5.0 | 6.2 |
| | 74b1 | 74b3 | 74b1 | 74b3 | |
| EMB. 2 | 10.7 | 21.4 | 11.2 | 5.6 | 5.6 |

*¹“ER” is the electric resistance.
*²“MCA” is the maximum current amount.
*³“MCAD” is the maximum current amount difference.

The maximum current amount of each heat generating element at the AC voltage of 120 V was calculated. The maximum current amounts of the heat generating elements 64b1 and 64b 3 is the comparison example 1 are 11.2 A and 5.0 A, respectively. A difference therebetween is 6.2 A. On the other hand, the maximum current amounts of the heat generating elements 74b1 and 74b3 in the embodiment 2 are 11.2 A and 5.6 A, respectively. A difference therebetween is 5.6 A. That is, the maximum current amount difference in the embodiment 2 is smaller than the maximum current amount difference in the comparison example 1. For this reason, also in the constitution of the embodiment 2, a fluctuation in maximum current amount during switching of the heat generating element can be reduced, so that a flicker phenomenon suppressing effect can be further enhanced.

As described above, the heat generation region connected to each of opposite ends of the third heat generating element is extended in the longitudinal direction, so that similarly as in the embodiment 1, during the sheet passing of the sheet narrow in width, the switching frequency of the heat generating element can be lowered. In addition, an extension amount of the third heat generating element (or the second heat generating element) is increased and is made longer than the extension amount of the first heat generating element, so that a difference in current amount fluctuation during the heat generating element switching can be further reduced and a risk of the flicker phenomenon can be further reduced.

Incidentally, in the embodiment 2, the case where the A4-size sheet is passed was described, but in the case where the B5-size sheet is passed, the heat generating elements 74b1 and 74b2 are used and formed in accordance with a way of thinking and a calculating method which are described in the embodiment 2, a similar effect can be realized. That is, the heat generating element 74b2 may also be constituted so as to function as the third heat generating element. In this case, the heat generating element 74b2c as a third portion, the heat generating element 74b2 as a first portion, and the heat generating element 74b2b as a second portion are connected in series with each other in this order. A way of thinking and a calculating method in this case is used are the same as those in the embodiment 2, and therefore, described thereof will be omitted.

As described above, according to the embodiment 2, the flicker phenomenon can be suppressed while realizing the downsizing and improving the productivity of the printing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-209634 filed on Dec. 2, 2024, which is hereby incorporated by reference herein in its entirety.

What is claimed is:

1. A heating member comprising:
a substrate;
a first heat generating element disposed at one end portion of the substrate in a widthwise direction of the substrate;
a second heat generating element disposed at the other end portion of the substrate in the widthwise direction and electrically connected in parallel with the first heat generating element; and
a third heat generating element disposed between the first heat generating element and the second heat generating element in the widthwise direction,
wherein a combined resistance of the first heat generating element and the second heat generating element is smaller than a resistance of the third heat generating element, and
wherein along a longitudinal direction of the substrate, the third heat generating element includes a first portion having a length shorter than respective lengths of the first and second heat generating elements, and includes a second portion and a third portion on mutually opposite longitudinal sides of the first portion, each of the second and third portions having a lower resistance of the first portion, and
wherein the second portion, the first portion, and the third portion are connected in series with each other in this order.

2. The heating member according to claim 1, wherein the third heat generating element is longer than the first heat generating element in the longitudinal direction.

3. A fixing device for fixing a toner image on a recording material, comprising:
a heating member according to claim 1;
a switching unit configured to selectively supply power either to the first and second heat generating elements or to the third heat generating element; and
a control unit configured to control the switching unit,
wherein the control unit is configured to increase a proportion of time during which power is supplied to the third heat generating element as a temperature of the fixing device indicative of a heat accumulation amount, detected by a temperature sensor, increases.

4. The fixing device according to claim 3, wherein the control unit changes, depending on the detected temperature, a ratio between a time in which power is supplied to the first and second heat generating elements and a time in which power is supplied to the third heat generating element.

5. The fixing device according to claim 4, wherein the control unit is configured to vary a total length of a control cycle during which power is alternately supplied to the first and second heat generating elements and to the third heat generating element, depending on the detected temperature.

6. The fixing device according to claim 3, further comprising:
a film heated by the heating member; and
a pressing roller configured to form a nip in cooperation with the film,
wherein the heating member is disposed inside the film, and the film is nipped by the heating member and the pressing roller, and
wherein the toner image on the recording material is heated through the film in the nip.

7. An image forming apparatus comprising:
an image forming unit configured to form a toner image on a recording material; and
a fixing device according to claim 3, in which the toner image formed by the image forming unit is fixed.
